(19) United States
(12) Patent Application Publication
(10) Pub. No.: US 2003/0063613 A1
(43) Pub. Date: Apr. 3, 2003

(54) Label switched communication network and system and method for path restoration

(76) Inventors: Walter Joseph Carpini, Stittsville (CA); Barry Ding Ken Mark, Kanata (CA); Peter Steven Pieda, Kanata (CA)

Correspondence Address: SMART & BIGGAR, P.O. BOX 2999, STATION D, 55 METCALFE STREET, SUITE 900, OTTAWA, ON, K1P5Y6, CA

(21) Appl. No.: 09/964,766

(22) Filed: Sep. 28, 2001

(51) Int. Cl. H04L 12/28; H04L 12/56

(52) U.S. Cl. 370/401; 370/216

(57) ABSTRACT

A communication network is provided which includes a primary label switched path having a plurality of switching routers. The communication network includes a secondary label switched path which extends from a selected primary path switching router, bypasses a section of the primary path and rejoins the primary path at a position downstream of the selected switching router. The selected switching router is conditioned to re-route data intended for transmission on the primary path, onto the secondary communication path in response to a fault on the section of the primary path which is bypassed by the secondary path to restore data transmission.

### FIELD OF THE INVENTION

The present invention relates to a label switched communication network, and in particular to a system and method for restoring communications on such a network in the event of a fault or failure condition.

### BACKGROUND OF THE INVENTION

A typical communication network comprises a number of nodes interconnected by communication links and forms communication paths between different nodes on the network. Communication signals are routed over the network from a source node to a predefined destination node over a path which may include a number of nodes and links. Information defining the particular path to be taken and the destination may be carried with the data, for example in a packet header which is read at each node and controls a router at each node to direct the data along the next appropriate communication link of the specified path. This method of data transmission may be referred to as tag or label switching of which asynchronous transfer mode (ATM) is a well-known example and another is multi-protocol label switching (MPLS) which has been proposed more recently.

A typical requirement of a customer when requesting a connection between two nodes in a communication network is the provision of a protection or restoration scheme which restores communication in the event of a fault or failure in the path carrying the data traffic. In one such protection scheme, an indication of a fault or failure in the communication path is transmitted back to the source node of that path which then discovers an alternative path and re-routes the data over that alternative path to the destination node. The maximum time allowed to restore a connection may be a requirement specified by a standard by the ITU. For example, over a long-haul optical network, the ITU standard specifies a maximum of 10 msec to detect an error and a maximum of 50 msec to recover from the error. While this may be achievable over a path with relatively few nodes, the time needed to recover from a failed connection significantly increases with the number of nodes. Therefore, in larger metropolitan networks with their mesh-like topologies, the required restoration times expected from a network connection becomes increasingly harder to achieve.

### SUMMARY OF THE INVENTION

According to one aspect of the present invention, there is provided a communication network including a first communication path having a plurality of switching routers, a second communication path having at least one communication path element different from the first communication path and extending from a predetermined one of the switching routers to a position on the first communication path located at a distance from the predetermined switching router of less than the length of the first communication path, wherein the predetermined switching router includes output means for outputting data with a label for routing data along one of the first and second communication paths, and routing means responsive to a fault in the transmission capability of the first communication path between the predetermined switching router and the position for routing data received by the predetermined switching router for transmission along the first communication path, along the second communication path.

Advantageously, in this arrangement, the communication network includes a switching router which is responsive to the occurrence of a fault on part of the first communication path to route data for transmission over the first communication path, along a second communication path which bypasses the part of the first communication path for which the switching router is responsible, thereby bypassing the fault and restoring transmission of data traffic to its intended, destination switching router on the first communication path. Advantageously, this restoration path configuration is scaleable, since the switching router is only responsible for managing the restoration of data transmission over a part or section of the first communication path. Furthermore, in this configuration, the alternative or restoration path which is traditionally required to bypass as many resources between the source and destination nodes of the primary or working path as possible, need only bypass part of the primary or working path and therefore fewer resources may be required for the secondary path.

In one embodiment, the selected switching router includes means for establishing the second communication path. This embodiment is particularly advantageous in the case of restoration, where a secondary path is established after the occurrence of a fault on the first communication path. In this case, the switching router need only establish a secondary path which bypasses the section of the first communication path affected by the fault, and therefore the alternative path may be determined from only a section of the whole network topology, which is likely to be considerably faster than determining an alternative path from the source to the destination node involving the whole network topology.

In one embodiment, the selected switching router may be responsive to a direct indication of a fault condition on the first communication path to re-route data on the second communication path. Advantageously, since the selected switching router is responsible for restoring data transmission over part of the primary communication path, a signal indicating the occurrence of a fault need only propagate over that section of the first communication path for which the selected switching router is responsible, and therefore propagates through fewer resources of the first communication path, each of which has an associated propagation delay, and therefore the fault signalling time and time to restore data transmission can be considerably reduced.

In one embodiment, the selected switching router is a switching router intermediate between the source and destination nodes on the first communication path. In another embodiment, the predetermined switching router may comprise the source node of the primary communication path.

In another embodiment, the first communication path includes a plurality of switching routers, each having routing means responsive to a fault in the transmission capability of the first communication path to route data onto a respective second communication path.

According to another aspect of the present invention, there is provided a method of conditioning a communication network for restoring data transmission between a first node and a second node of the network, comprising the steps of: selecting a switching router on a first communication path between the first and second node which is connected to a second communication path which adjoins the first communication path at a position downstream of the selected switching router, conditioning the switching router to route data onto one of the first and second communication paths in response to a label associated with the data and to respond to a fault in the transmission capability of said first communication path between the switching router and the position to route data intended for transmission along said first communication path, onto said second communication path.

Advantageously, in this configuration, since the intermediate switching router is responsible for managing path restoration over a section of the first communication path, the secondary path can be selected to bypass only that section of the first communication path for which the intermediate switching router is responsible, and therefore requires fewer resources than are required in prior art restoration schemes in which for protection, the secondary path extends between the source and destination nodes. In the case of restoration, this configuration allows a suitable secondary path, which bypasses the fault, to be discovered more quickly, since fewer resources are involved.

One embodiment further comprises the step of conditioning the switching router to detect the presence of a fault between the switching router and the position at which the secondary path joins the primary path, and to respond to the fault by re-directing data intended for transmission along the primary path onto the secondary path. This arrangement allows faster fault detection and path restoration not possible in prior art restoration schemes, since the presence of a fault need not be transmitted all the way back to the source node before the intermediate switching router takes action to restore data transmission.

According to another aspect of the present invention, there is provided a method of restoring communication between an input node and an output node due to failure of a first communication path between the nodes, comprising the steps of indicating a fault condition to a switching router on the first path positioned between the location of the fault and the input node, re-routing data received at the switching router intended for transmission over the first communication path along a second path and returning the data to the first path at a position downstream of the fault location.

According to another aspect of the present invention, there is provided a method of restoring communication between an input node and an output node in a network due to a fault in a first communication path between the nodes, comprising the steps of indicating a fault condition on the first path to the input node, re-routing data at the input node intended for transmission over the first communication path along a second communication path and returning the data to the first communication path at a position between the fault and the output node.

According to another aspect of the present invention, there is provided a method of evaluating a node for redirecting data from a first communication path, having a source node and a destination node, along a second communication path, comprising the steps of: selecting a test node on the first communication path between the source node and the destination node, selecting a test node on the second communication path, determining the value of a parameter of a test path between the test nodes, and evaluating the test node on the first path for re-directing data to the second path based on the determined value of the parameter.

According to another aspect of the present invention, there is provided a method of selecting an alternative path for carrying data intended for transmission along a communication path between a source node and a destination node, comprising selecting a plurality of alternate paths connected between an intermediate node of the communication path and the destination node, and selecting from the plurality of alternate paths, the path which shares the minimum number of links with the communication path between the intermediate node and said destination node.

### BRIEF DESCRIPTION OF THE DRAWINGS

Examples of embodiments of the present invention will now be described with reference to the drawings, in which:

FIG. 1 shows a communication network according to a first embodiment of the present invention;

FIG. 2 shows a schematic diagram of switching router in accordance with an embodiment of the present invention;

FIG. 3 shows a communication network in accordance with another embodiment of the present invention;

FIG. 4 shows a schematic diagram of a switching router in accordance with another embodiment of the present invention;

FIG. 5A shows a communication network in accordance with another embodiment of the present invention;

FIG. 5B shows a communication network in accordance with another embodiment of the present invention;

FIG. 6 shows a communication network in accordance with another embodiment of the present invention;

FIG. 7 shows a communication network in accordance with another embodiment of the present invention;

FIG. 8 shows a communication network in accordance with another embodiment of the present invention;

FIG. 9 shows a communication network in accordance with another embodiment of the present invention;

FIG. 10A shows a communication network in accordance with another embodiment of the present invention;

FIG. 10B shows a communication network in accordance with another embodiment of the present invention;

FIG. 11 shows a communication network in accordance with another embodiment of the present invention;

FIG. 12 shows a communication network in accordance with another embodiment of the present invention;

FIG. 13 shows an example of a communication network having a bridge link, and

FIGS. 14A to 14G show an example of a communication network to which an embodiment of a method of selecting a segment switching router is applied.

### DETAILED DESCRIPTION OF EMBODIMENTS

The applicant's U.S. Provisional Patent Application Serial No. 60/290,633 filed on May 15, 2001 and entitled Method and Apparatus for Controlling Allocation and Stacking or MPLS Labels in Telecommunications Networks is incorporated herein by reference.

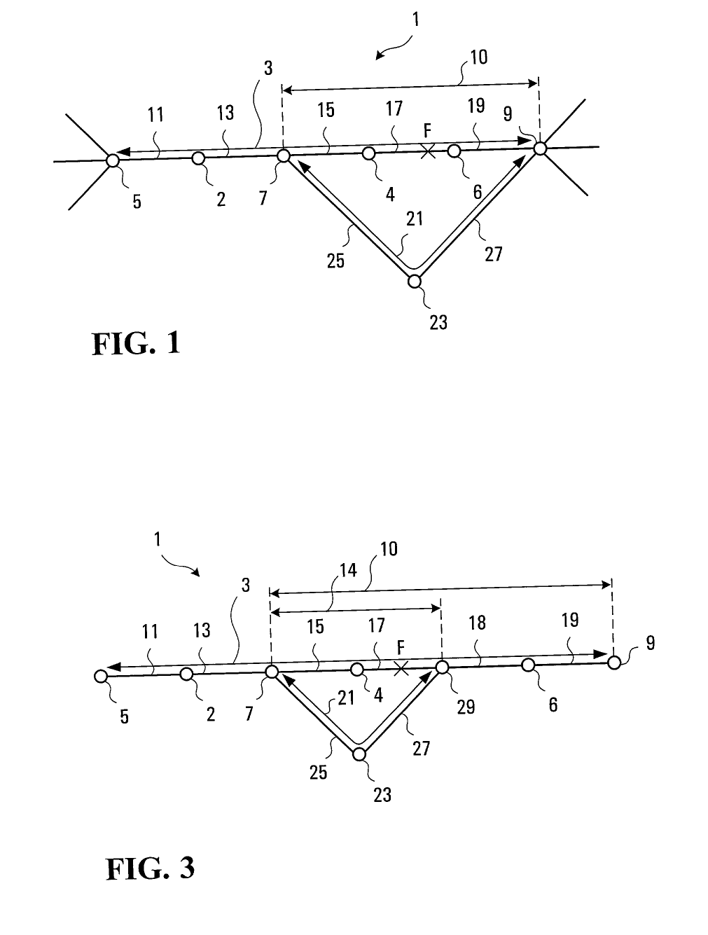

Referring to FIG. 1, a communication network, generally shown at 1, comprises a first communication path 3 which includes a first switching router 5, a second switching router 7 downstream of the first switching router and a third switching router 9 downstream of the second switching router 7.

The first communication path further includes a plurality of intermediate switching routers 2, 4, 6, and communication links 11, 13, 15, 17, 19.

The communication network 1 further comprises a second communication path 21 extending between the second and third switching routers 7,9, and which includes an intermediate switching router 23 and communication links 25, 27.

A first label switched path (LSP) is defined over the first communication path 3, and whose length is defined between a source node (e.g. ingress label edge router (LER)) and a destination node (e.g. egress LER). The first switching router 5 may comprise the source node, or an intermediate node of the label switched path, and the third switching router 9 may comprise the destination node of the label switched path or an intermediate node of the label switched path. Under normal operation, data specified for transmission on the first label switched path is directed from the first switching router 5 onto the first communication path 3 with a forwarding label defining the first LSP and is directed by successive switching along first communication path according to labels defining the first LSP.

The second communication path 21 provides an alternative path for carrying data between the second and third switching routers 7, 9, and may be used to carry data traffic intended for transmission along the first communication path if the section of the first communication path between the first and second switching routers fails. A label switched path is defined over the secondary path 21 for the purpose of re-routing data intended for transmission on the first communication path, onto the second communication path. For protection, the LSP on the second communication path may be established before the occurrence of a fault on the primary path 3, and for restoration, the LSP on second communication path may be established after the occurrence of a fault on the primary path. In either case, the secondary path LSP may be established by the second switching router 7 or by another switching router, for example another switching router on the primary communication path such as the ingress LER.

Advantageously, for the purpose of protection or restoration, the first or primary communication path is subdivided into sections so that an alternative path need only circumvent a section of the primary path rather than the entire primary path in the case of prior art restoration schemes. An alternate path may therefore be discovered and established more easily and quickly as it may involve fewer resources and may be based on a reduced topology of the entire network. This aspect of the scheme is particularly beneficial for restoration, where the alternative path must be discovered and established as quickly as possible after the occurrence of a fault.

In one embodiment, the second switching router 7 may be adapted to discover and establish an alternative path between itself and the third switching router 9. The benefit of this feature is two fold. Firstly, the resources required to discover, establish and switch data onto an alternative LSP which circumvents that section of the primary path for which the second switching router is responsible, are maintained at and by the second switching router rather than the source node, so that fewer resources are required at the source node to provide protection or restoration of the primary path. Secondly, since the second switching router is closer to the location of a fault on the second section of the primary path, than the source node, the occurrence of such a fault may be notified to the second switching router 7 sooner than to the source node, in which case, the second switching router may be adapted to respond to such a notification to establish and switch data to an alternative path, there by reducing the restoration time in comparison to a scheme in which restoration is initiated only after the occurrence of a fault has been notified to the source node.

Preferably, the second switching router is adapted to switch data from the primary path to the secondary path in response to the occurrence a fault on the section of the primary path for which the second switching router 7 is responsible. The communication network may be arranged such that a fault is detected by a switching router in close proximity to the fault, and a fault indication is transmitted by the most direct route to the switching router responsible for the section of the primary path in which the fault occurred. For example, referring again to FIG. 1, a fault “F” occurring on the primary path between the intermediate switching routers 4 and 6 may be detected by the upstream intermediate switching router 4 and notified to the immediately adjacent second switching router 7 over communication link 15. The second switching router 7 may itself include a fault detector for detecting a fault on the second section of the primary path.

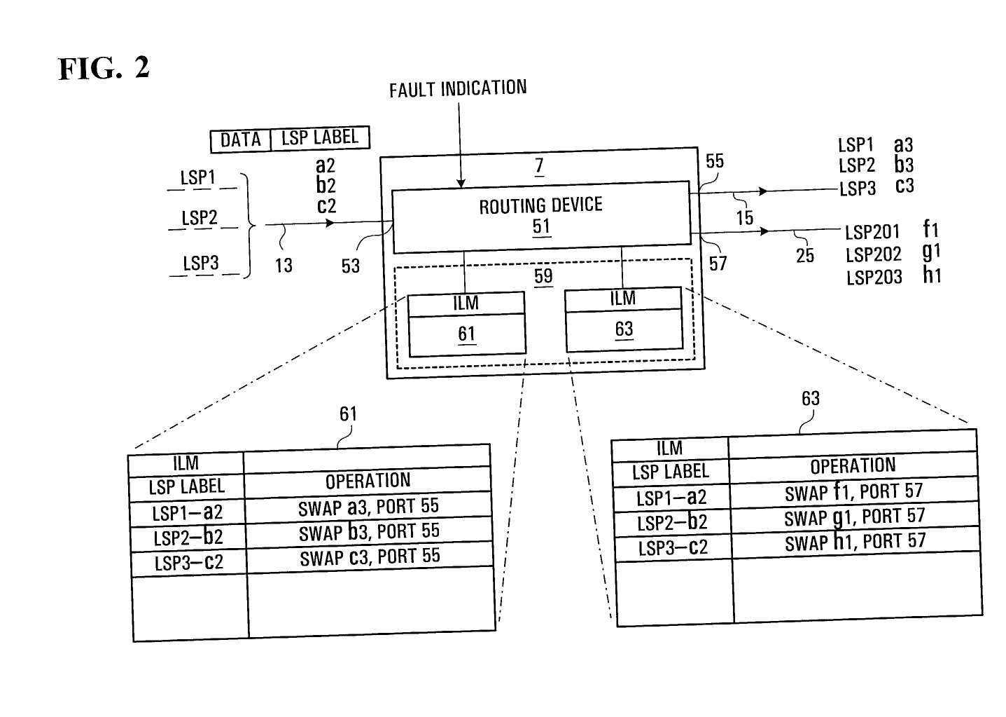

FIG. 2 shows a switching router according to an embodiment of the present invention, and which may be incorporated as the second switching router 7 in the communication network of FIG. 1. Referring to FIG. 2, the switching router 7 comprises a routing device 51 having an input port 53 and first and second output ports 55, 57. The input port is connected to a communication link 13 of the first communication path, the first output port 55 is connected to a communication link 15 of the first communication path and the second output port 57 is connected to a link 25 of the second communication path. The switching router 7 further includes a memory 59 associated with the routing device 51 for storing one or more incoming label maps (ILM) or forwarding tables 61, 63.

In the present embodiment, a first label switch path LSP1 is established on the first communication path between the first and third switching routers 5, 9 shown in FIG. 1. One or more other label switched paths LSP2, LSP3 may also be established over the first communication path or a different path which is connected to input port 53 of the routing device 51 and includes the second section of the primary path between the second and third switching routers 7,9. The first incoming label map 61 contains instructions enabling the routing device to identify data packets associated with the first LSP, LSP1, intended for transmission on the first communication path and to direct those data packets onto the next link of 15 of the first communication path. For example, as shown in the expanded view of ILM 61, the first entry contains the forwarding label a2, which is received by and identifies first LSP data packets, and an associated operation which causes the routing device to change label “a2” to label “a3” and to output the relabelled data packets from the first output port 55. The first incoming label map 61 also contains second and third entries which include respective forwarding labels “b2” and “c2” used to identify data packets associated with the second and third LSPs, LSP2, LSP3, and associated labelling and forwarding instructions, which causes LSP2 data to be relabelled with the next LSP2 forwarding label “b3” and output from the first output port 55, and LSP3 data to be relabelled with the next LSP3 forwarding label “c3” and again, output from the first output port 55.

To enable the switching router 7 to redirect data received within each of the first, second, and third LSPs from the first communication path to the second communication path, a second incoming label map 63 may be provided. Referring to the enlarged view of the second ILM 63, in this example, the first entry contains the forwarding label “a2” used to identify incoming LSP1 data, and an associated instruction which causes LSP1 data packets to be relabelled with the first forwarding label “f1” defining a secondary LSP 201 on the second communication path and to output the relabelled data packets onto the second communication path from the second output port 57. The second entry contains the forwarding label “b2” which identifies LSP2 data packets, and an associated instruction which causes the switching router to relabel LSP2 data packets with the first forwarding label “gl” of another LSP 202 established on the second communication path and output the relabelled LSP2 data on to the second communication path from the second output port 57. Similarly, the third entry contains the forwarding label “c2” identifying LSP3 data and a corresponding instruction which causes the switching router to relabel the LSP3 data with the first forwarding label “h1” of another secondary LSP established on the second communication path, and to output the relabelled data on to the second communication path from the second output port 57.

In the case of protection, each of the secondary LSPs, LSP201, 202, 203 on the second communication path are established prior to the occurrence of a fault on the section of the primary path protected by the secondary path, and the second incoming label map 63 may also be generated and stored in the memory 59 together with the first incoming label map 61 in advance of a fault on the primary path.

In the case of restoration, the routing device may be adapted to perform certain functions in response to a signal indicative of a fault or resulting from a fault on the section of the primary path for which the switching router is responsible. The switching router may be adapted to respond to a fault indication to discover a suitable secondary path over which data traffic can be redirected. In one embodiment, the switching router may be insensitive to the particular location of the fault on its section of the primary path and discover a secondary path which simply bypasses the entire section for which it is responsible, so that for example the secondary path meets the primary path at the destination node or at or beyond the next segment head switching router. In another embodiment, the switching router may be sensitive to the location of the fault on the primary path. The location of the fault and/or those resources affected by the fault may be identified in the fault indication signal or another signal. On receipt of the signal, the switching router discovers a secondary communication path which bypasses the fault and those resources affected by the fault and which may rejoin the primary path at a position beyond the fault but within the primary path section for which the switching router is responsible. Advantageously, in this embodiment the selection of an alternative path is predicated on the particular location of the fault permitting greater flexibility in selecting an optimal restoration path.

Once an alternative path has been selected, the switching router may be adapted to establish a secondary LSP over the secondary path for each LSP which is carried on the primary communication path. The switching router may be arranged to generate an incoming label map which enables the routing device to direct data carried within each LSP on the primary path onto a respective secondary LSP on the alternative path. The ILM may be generated as a second ILM or may be generated by over writing or otherwise modifying the original ILM for directing data over the primary communication path. Generation of the secondary path ILM may commence either before, during or after the secondary LSPs are established. The switching router uses the secondary path ILM to redirect data from the primary path onto the secondary path, thereby restoring data transmission around the failed resource or resources of the primary path.

Where appropriate, the functions of the switching router described above may be implemented either in hardware or in software, or a combination of both.

FIG. 3 shows a communication network according to another embodiment of the present invention. This communication network is similar to that shown in FIG. 1 and like parts are designated by the same reference numerals. Referring to FIG. 3, the network includes a first communication path 3 which includes first, second and third switching routers 5, 7 and 9. The network further includes a second communication path 21 which extends from the second switching router 7 and includes an intermediate switching router 23. The main difference between this embodiment and that shown in FIG. 1 is that the second communication path 21 joins the first communication path at a point which is intermediate between the second and third switching routers 7, 9. In this particular embodiment, the second section 10 of the first communication path between the second and third switching routers 7, 9 includes an additional switching router 29 to which the secondary communication path 21 is connected. In this embodiment, the second switching router 7 is responsible for redirecting data traffic intended for the primary path onto the secondary path in response to a fault on the section 14 of the primary path between itself and the additional switching router 29. The additional switching router 29 is adapted to recognize primary-path-fault-diverted data and to route the data from the secondary path back onto the primary path.

This embodiment illustrates an example of an implementation of a secondary communication path which functions to divert data around a fault and back onto the first communication path for further transmission to the destination node of the primary path, in contrast to a secondary path which is extended to carry data to the destination node without further transmission along the first communication path. The embodiment shown in FIG. 3 may be implemented where it is convenient to return data traffic, where possible, from the secondary path to resume transmission over the primary path, or where is it is not possible or convenient to extend the secondary path to rejoin the primary path at a position downstream of the additional switching router 29.

To redirect data from a primary LSP on the first communication path, a secondary LSP may be established on the second communication path 21 between the segment head switching router 7 and the additional switching router 29. The secondary LSP may terminate at the additional switching router 29, and the additional switching router 29 may be conditioned to transfer the diverted data back onto the next segment of its primary LSP on the first communication path. In this case, the additional switching router 29 may be adapted to label diverted data received from the secondary LSP with the same forwarding label had the data been received from the corresponding primary LSP.

In another embodiment, the secondary LSP may extend beyond the additional switching router 29 over part of the remaining section of the primary communication path or over the entire remaining section of the primary path to the destination node. A plurality of secondary LSPs may be established on the secondary communication path 21 and each may terminate at a different location on the primary communication path. The segment head switching router 7 may comprise any of the embodiments of the segment head switching router described above in connection with FIG. 1 and may be adapted to protect or restore data traffic or a combination of both, for example for different primary LSPs.

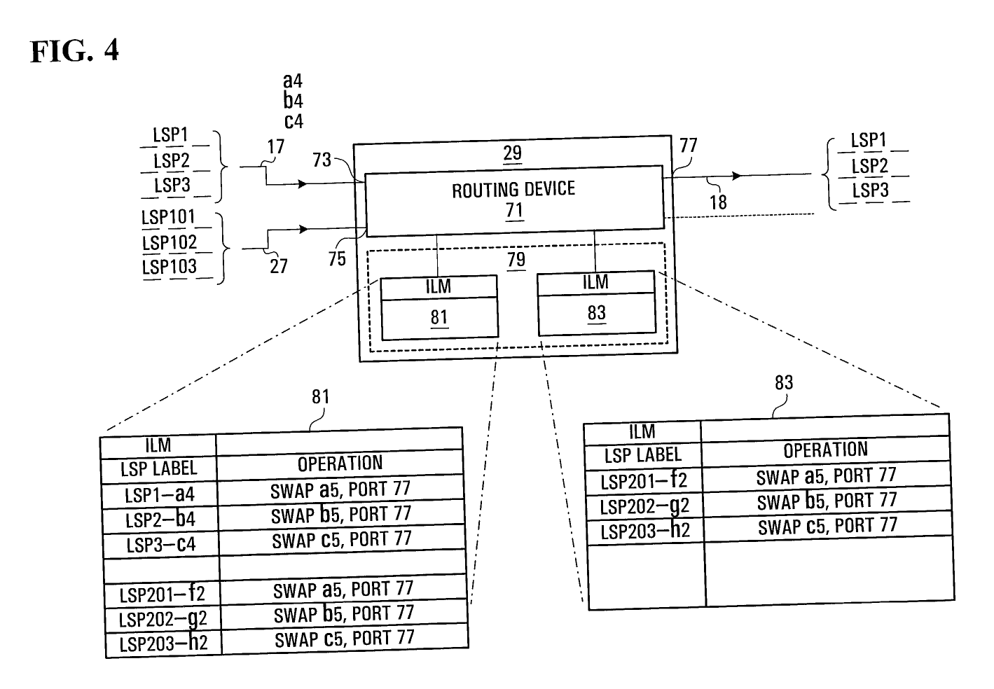

An example of an embodiment of the additional or intermediate switching router which serves to merge diverted data back onto the primary path will now be described with reference to FIG. 4. Referring to FIG. 4, the switching router 29 comprises a routing device 71 having first and second input ports 73, 75 and an output port 77. The first input port 73 is connected to communication link 17 of the first communication path 3, the second input port 75 is connected to the second communication link 27 of the second communication path 21, and the output port 77 is connected to the downstream communication link 18 of the primary communication path. The switching router 29 further includes a memory 79 for storing one or more incoming label maps or forwarding tables 81, 83. The incoming label map(s) contain instructions for enabling the routing device 71 to forward data specified for transmission within a particular label switched path to forward the data over the next link of the specified LSP. In the present example, a plurality of primary LSPs are established over the first communication path and a secondary LSP corresponding to each primary LSP is established on the secondary communication path, each secondary LSP terminating at the additional switching router 29. Referring to the expanded view of the first ILM 81, the ILM contains an entry corresponding to each primary LSP including a forwarding instruction. In particular, the first entry includes a forwarding label “a4” which identifies data associated with a primary path LSP, LSP 1. The first entry further includes a forwarding instruction which causes the routing device 71 to relabel LSP1 data with the forwarding label “a5” and to output the data from the output port 77 onto the next link 18 of the primary communication path. Similarly, the second and third entries contain forwarding labels “b4” and “c4” which identify data associated with other primary LSPs, LSP2 and LSP3, and an associated forwarding instruction which causes the data to be relabelled with the next appropriate forwarding label and output onto the next link 18 of the primary path from the output port 77.

The first incoming label map 81 also includes entries for enabling the routing device to direct data which is diverted onto the secondary communication path back onto the primary communication path. In the present embodiment, a secondary LSP is established for each primary LSP. Thus, secondary LSPs 201, 202 and 203 serve as secondary LSPs for primary LSPs 1, 2 and 3, respectively. The fourth entry in the first ILM 81 includes a forwarding label “f2” which identifies data associated with the secondary LSP 201, and an associated instruction which causes the routing device to relabel data having label “f2” with the LSP1 forwarding label “aS” and to output the data from output port 77 onto the next link 18 of the primary communication path. In this way, data originally intended for transmission within the primary LSP, LSP1, which is diverted onto the corresponding secondary LSP 201, is transferred back onto the primary LSP, LSP1 for continued transmission along the primary communication path. Similarly, the fifth and sixth entries contained within the first ILM 81 include forwarding labels “g2” and “h2” which identify data associated with the other secondary LSPs, 202, 203, and an associated instruction which causes the routing device to relabel the secondary LSP data with the appropriate next forwarding label associated with a respective primary LSP, LSP2, LSP3 and to output the data from the output port 77 onto the next link 18 of the primary communication path. In this way, the switching router 29 returns diverted data associated with each primary LSP back onto a respective primary LSP.

In another embodiment, the forwarding instructions for each secondary LSP may be contained within a separate ILM 83 rather than the same ILM 81 which contains forwarding instructions for each primary LSP. This arrangement may be implemented where the second communication path is connected to a port associated with a different routing device or interface within the additional switching router 29.

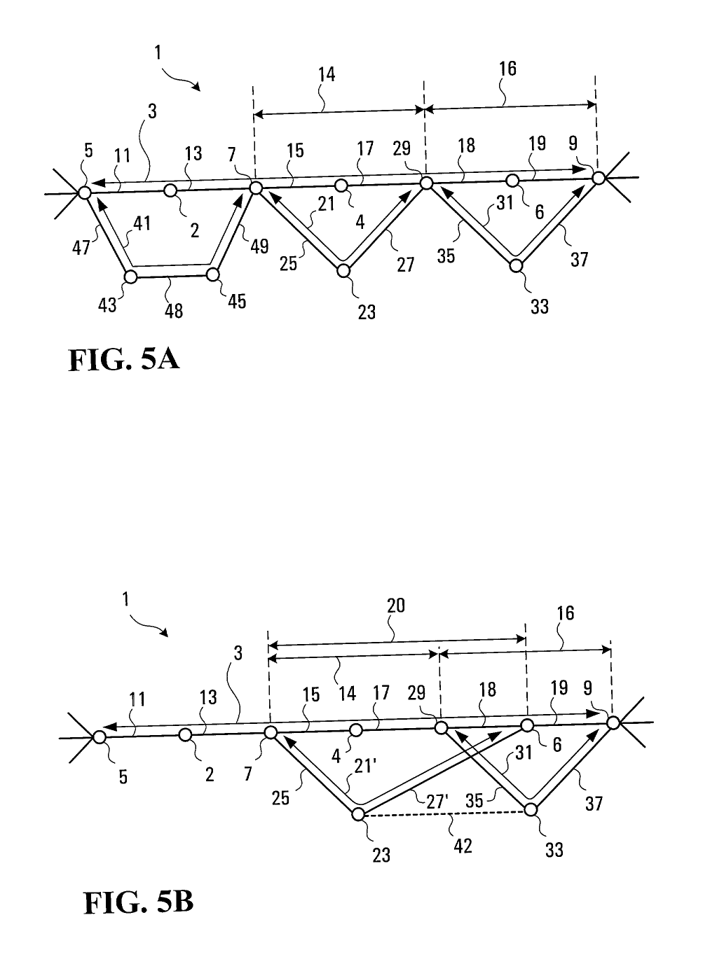

FIG. 5A shows a communication network according to another embodiment of the present invention. This embodiment is an extension of the embodiment shown in FIGS. 1 and 3 and like parts are designated by the same reference numerals.

Referring to FIG. 5A, the network 1 includes a first communication path 3 which includes first, second and third switching routers 5, 7 and 9 and an additional switching router 29, and intermediate switching routers 2, 4, 6. The network further includes a second communication path 21 extending from the second switching router 7 to the additional switching router 29 and which includes an intermediate switching router 23. The network also includes a third communication path 31 which extends from the additional switching router 29 to the third switching router 9, and which includes an intermediate switching router 33.

The second switching router 7 functions to detect or otherwise respond to a fault or failure in the transmission capability of the segment 14 of the first communication path 3 between the second switching router 7 and the additional switching router 29, and in the event of a fault or failure condition, to re-route data intended for transmission along the segment 14 of the primary path between the second switching router 7 and the additional switching router 29, along the second communication path 21, thereby restoring data transmission between the second and additional switching routers 7, 29. The second switching router 7 may function in the same way as any of the embodiments described above in connection with FIGS. 1, 2 and 3.

Referring again to FIG. 5A, the additional switching router 29 is conditioned to respond to a fault or failure condition in the transmission capability of the segment 16 of the first communication path between the additional switching router 29 and the third switching router 9 and may include a fault detector or otherwise be adapted to respond to a signal resulting from a fault on this segment 16. The additional switching router 29 further includes re-routing means responsive to the fault condition for re-routing data intended for transmission over the segment 16 of the first communication path, along the third communication path 31. Thus, in this embodiment, the second switching router 7 monitors faults and manages path restoration over the segment 14 of the first communication path between the second switching router 7 and the additional switching router 29, and the additional switching router 29 monitors the segment 16 between the additional switching router 29 and the third switching router 9 and manages path communication restoration in the event of a fault on that segment.

In one embodiment, the flow of data along each of the second and third communication paths, may be controlled according to a predetermined labelling system, for example, as described above, in connection with any of FIGS. 1 to 4. In one embodiment, one or more respective secondary LSP's may be established on each of the second and third communication paths. The labelling system could be established either dynamically in response to a fault condition, i.e. for restoration, or the second and third communication paths could be established prior to detecting a fault i.e. for protection, to assist in minimizing the data transmission recovery time.

In the event of a fault condition on the segment 16 between the additional switching router 29 and the third switching router 9, data transmission may be restored by invoking the third communication path as follows. On receipt of data by the additional switching router 29 which is being transmitted over the previous segment 14 of the first communication path 3, the additional switching router 29 reads the label associated with the data, assigns a new label to the data and routes the data onto the first link 35 of the third communication path 31 to the intermediate switching router 33. The label assigned to the data by the additional switching router 29 is previously established by the intermediate router 33 to cause the intermediate switching router 33 to route that data over the next link 37 of the third communication path 31 to the third switching router 9.

In the event of a simultaneous fault condition on both segments 14 and 16 of the first communication path, the additional switching router 29 may be further adapted to re-route data received from the second communication path 21 along the third communication path 31. In one such embodiment, the additional switching router 29 is arranged to recognize, according to the predefined labelling system established for the second communication path, data received over the second communication path intended for further transmission over the first communication path, and will route data back onto the first communication path segment 16 if it can. However, in the event of a fault condition on segment 16, the additional switching router 29 recognizes the label which indicates that data received over the second communication path is to be returned to the first communication path and assigns to the data an appropriate label established for the third communication path and re-routes the data over the first link 35 of the third communication path 31. This functionality may be implemented by configuring the switching router 29 described above and shown in FIG. 4, with a specific ILM containing appropriate forwarding labels of each secondary LSP associated with each primary LSP and a corresponding labelling and forwarding instruction which causes the additional switching router 29 to route the specified data over a corresponding LSP established on the third communication path.

The embodiment described above in conjunction with FIG. 5A illustrates an example of a transmission recovery scheme where the primary path includes a number of segments whose boundaries extend from one segment head to the segment head responsible for the next segment.

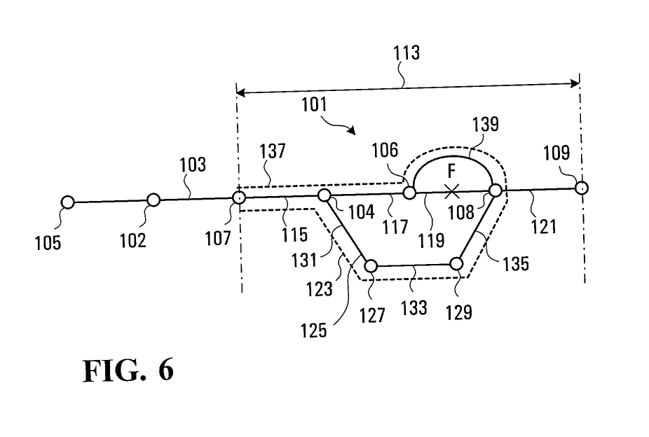

Referring to FIG. 5B, in an alternative embodiment of the communication network of FIG. 6, the secondary communication path 21′ may rejoin the primary path 3 at a position between the additional switching router 29 and the third switching router 9. In this example, the second communication path 21′ rejoins the primary communication at a primary path intermediate switching router 6 between the additional and third switching routers 29, 9.

In this embodiment, the second switching router 7 may serve as the segment head node responsible for directing data over the second communication path 21′ in response to a fault in the section 14 of the primary communication path 3 between the second and additional switching routers 7, 29. Similarly, the additional switching router 29 may be adapted to serve as the segment head node responsible for re-directing data traffic over the third communication path 31 in response to a fault in the section 16 of the primary path between the additional switching router 29 and the third switching router 9. In this case, the second and additional switching routers may function in a similar manner to the second and additional switching routers 7, 29 of the embodiment shown in FIG. 5A.

In another embodiment, the segment of the primary path for which the second switching router 7 is responsible may be extended to include a portion of the next segment 16. For example, as shown in FIG. 5B, the second switching router may be adapted to re-direct data traffic in response to a fault on the extended section 20 of the primary communication path between itself and the position at which the second communication path 21′ rejoins the primary path, which in this example is at the intermediate switching router 6. Advantageously, since the segment head 29 responsible for the next segment 16, and the adjacent communication link 18 are included within the segment for which the second switching router 7 is responsible, this configuration also provides protection or restoration against failure of either of these two resources and therefore provides a more robust protection or restoration scheme.

The intermediate switching router 6 may be conditioned to return data received from the second communication path 21′, intended for transmission on the primary communication path 3, to the primary path for further transmission to the third switching router 9. For example, this functionality may be implemented by configuring the intermediate switching router 6 to function in the same or similar manner to the embodiment described above in connection with FIG. 4.

In the event of a simultaneous fault or failure of the primary communication path in both section 14 between the second and additional switching routers 7, 29 and in the link 19 between the intermediate switching router 6 and the third switching router 9, the intermediate switching router 6 may be adapted to route data received over the second communication path back to the intermediate switching router 29 which then routes the data over the third communication path 31 to the third switching router 9. This alternative path may be established as a label switched path and may be established prior to the occurrence of a fault, i.e. for protection, or after the occurrence of a fault in the link 19 of the primary path between the intermediate and third switching routers 6, 9. This alternative LSP may be established by for example the intermediate switching router 6 or by the additional switching router 29.

In another embodiment, the second switching router 7 may be adapted to detect or otherwise respond to a fault condition in the segment 16 between the additional switching router 29 and the third switching router 9 and to re-route data received from the first switching router 5 intended for transmission along the first communication path, along a fourth communication path, defined by the intermediate switching router 23 of the second communication path 21′, the intermediate switching router 33 of the third communication path and the third switching router 9. This embodiment assumes a communication path 42 exists between the two intermediate switching routers 23, 33. This embodiment is particularly advantageous in restoring transmission in the event of a fault also being detected in the segment 14 between the second and additional switching routers 7, 29.

Any of the embodiments of the communication network described above and shown in FIGS. 1 to 5B may include a secondary communication path between the first and second switching routers to provide an alternative path for data transmission in the event of a failure on the primary communication path between the first and second switching routers 5, 7. Thus, the first switching router may be conditioned to function as the segment head responsible for the section of the primary path between itself and the second switching router, and to re-route data intended for transmission on the primary communication path onto the secondary communication path in response to a fault on that section. An example of a secondary communication path between the first and second switching routers is shown in FIG. 5A and includes intermediate switching routers 43, 45 and communication links 47, 48 and 49. One or more secondary label switched paths may be established over the secondary communication path 41, either before the occurrence of a fault on the primary path, i.e. for protection, or in response to a fault on the primary path, i.e. for restoration. The first switching router may be adapted to establish one or more secondary LSPs over the secondary communication path 41 and may function in the same or similar manner to the second switching router described above in connection with FIG. 2.

Advantageously, the communication restoration scheme described above in connection with FIGS. 1 to 5B is fully scalable into any size of network as restoration is monitored and managed over path segments rather than over an entire network from a single, source node. Path restoration may be managed per path segment independently of other segments, or may be managed jointly by two or more path segments. The secondary path for one or more segments of the primary path may rejoin the primary path at the segment head node for the next path segment, an example of which is shown in FIG. 5A, or may rejoin the primary path at a position beyond the segment head node of the next primary path segment, as shown in FIG. 5B.

In embodiments of the present invention, the first and second communication paths may share one or more of the same resources e.g. communication links and switching elements. In general, the second communication path will have at least one communication element which is different to the first communication path so that the second communication path provides an alternative route around the unshared component(s) should that all those component(s) fail. FIG. 6 shows an example of a communication network in which the secondary communication network in which the secondary communication path shares a number of resources with the primary path.

Referring to FIG. 6, a communication network to 101 comprises a first communication path 103 having first, second and third switching routers 105, 107 and 109 and intermediate switching routers 102, 104, 106, 108. The second switching router 107 is responsible for restoring data transmission between itself and the third switching router 109 in the event of a fault on the section of 113 of the first communication path between the first and second switching routers 107, 109. This section 113 of the first communication path includes first, second and third intermediate switching routers 104, 106, 108 and intermediate communication links 115, 117, 119, 121. The communication network further includes a second communication path 123 (shown by a dashed line for clarity) which is established between the second switching router 107 and the third intermediate switching router 108, and includes communication link 115 and intermediate switching routers 104 of the first communication path, and a separate path 125 between the second and fourth intermediate switching routers 104, 108, which includes an intermediate switching router 123 and communication links 131, 133 and 135.

Using restoration as an example, the second switching router 107 establishes a label switched path over the second communication path 123 in response to a fault F between the second and fourth intermediate switching routers 104, 108. The secondary LSP is established such that a path is discovered which is sufficient to bypass the fault but which also uses a number of the same resources as the primary communication path. A secondary LSP which shares a number of resources with the first communication path may also be established prior to the occurrence of a fault, for protection.

In another embodiment, the secondary communication path may be arranged to share as many of the same resources with the primary path, as possible. For example, referring again to FIG. 6, a secondary path from the second switching router 107 may be established to bypass a single resource, i.e. the resource affected by the failure, for example communication link 119 between the third and fourth intermediate switching routers 106, 108. In this embodiment, the secondary path 137 (shown by a dashed line for clarity) may include the second and third intermediate switching routers 104, 106, communication links 115, 117 of the primary path and, for example a single communication link 139 between the third and fourth intermediate switching routers 106, 108. This secondary communication path may be established either before or after the occurrence of a fault, i.e. for protection or restoration. The topology of the secondary communication path may be determined by the second switching router 107. The second switching router may establish one or more secondary LSPs over the secondary communication path. In this embodiment, the fourth intermediate switching router 108 functions to direct data received either over the primary or secondary communication path, onto the primary communication path to the third switching router 109.

In order to achieve the required, short data transmission recovery times, embodiments of the present invention provide protection or restoration across a path segment rather than across the entire path. A primary, or working path is divided into one or more path segments, and each path segment has a segment head switching router which may be responsible for establishing an alternative path to the next segment head or to the destination node. A segment head node may have knowledge of the topology of the portion of the network associated with the portion of the primary path for which it is responsible and may also have knowledge of the topology of an enlarged portion of the network, for example a larger portion or the entire communication network with which the primary path is associated.

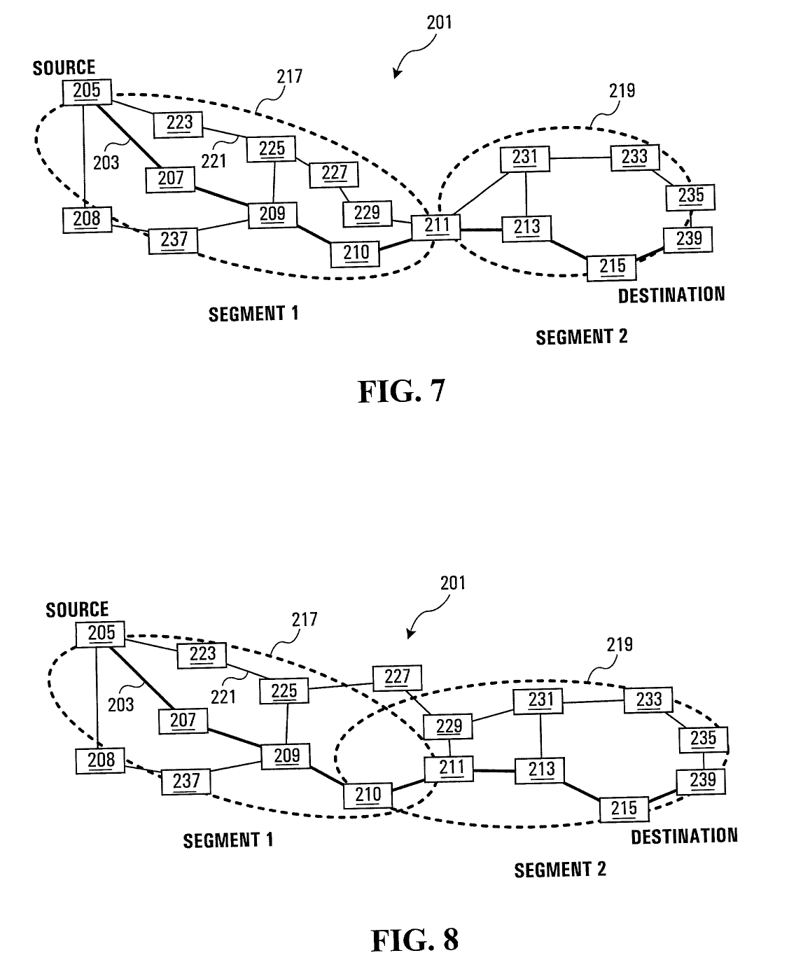

In the case of protection services, preferably, the alternative path does not share any risks, for example node or link with the primary hops in the path segment being protected. However, the alternative path can share risks with other resources in other segments of the primary path. The path segments can be non-overlapping as illustrated in FIGS. 1, 3 and 5A, or overlapping, as shown in FIG. 5B. Further examples of non-overlapping and overlapping path segments will be described below with reference to FIGS. 7 and 8.

In a network having non-overlapping segments, a single segment head joins two adjacent segments at a single node. Advantageously, this provides robust restoration capabilities for each segment. However, since the segment head is shared by both segments, the segment head constitutes a risk for node failures. Another embodiment of a network path divided into non-overlapping segments is shown in FIG. 7. Referring to FIG. 7, a communication network generally shown at 201 includes a primary communication path 203 having a source node 205 and a destination node 239 and a plurality of intermediate nodes 207, 209, 210, 211, 213, 215. The primary path 203 is divided into a first segment 217 and a second segment 219 (shown by the dashed lines), and one of the intermediate nodes 211 serves as the segment head for the second segment 219 of the primary communication path 203. The source node 205 is responsible for restoring data traffic between itself and the segment head node 211 and the intermediate segment head node 211 is responsible for restoring traffic between itself and the destination node 239. To protect the first segment 217 of the primary path, preferably a secondary path 221 is established between the source node 205 and the intermediate segment head node 211 which does not share any resources with the first segment 217 of the primary path. For example, the secondary communication path may be defined by intermediate nodes 223, 225, 227 and 229, and the segment head node 211 of the second segment. A secondary path is also established to protect the second segment of the primary path which also preferably does not share any resources of the second segment of the primary path, and may be defined by intermediate nodes 229, 231, 233 and 235, and the destination node 239.

In a network having overlapping segments, the previous segment has at least one node downstream of the segment head of the next segment. In other words, the segment head of the next segment is defined as a node upstream of the last node of the previous segment. An example of a network in which the path has overlapping segments is shown in FIG. 8.

The network shown in FIG. 8 is similar to that shown in FIG. 7, and the like paths are designated by the same reference numerals. The main difference between this communication network and that shown in FIG. 7 is that the first segment 217 of the primary path overlaps the second segment 219 of the primary path 203. The source node 205 is responsible for restoring traffic in the first segment between itself and the last node 211 in that segment. The intermediate node 210 which immediately precedes the last node 211 in the first segment is responsible for path restoration over the second segment 219 between itself and the destination node 239. In the event of a failure of the last node 211 in the first segment, the segment head 210 which is responsible for restoration over the second segment 219, in which the last node 211 is included, restores communication over its discovered alternate path to the destination node 239. Conversely, in the event of a failure of the segment head node 210 of the second segment 219, which is included in the first segment 217, the source node 205 invokes its discovered alternate path which circumvents the segment head 210. In addition, the last node 211 of the first segment which is the next node adjacent to the segment head 210 of the second path segment 219 may now be re-designated as the segment head for the second segment.

The communication network shown in FIG. 8 having overlapping segments can be implemented in networks having either uni-directional links or bi-directional links. In optical networks with uni-directional links, the first segment head restores those links directed towards the destination. The other segment head restores those links directed towards the source.

Fault or Failure Detection

Generally, when a fault is detected on a link, one or both node(s) adjacent to the fault is (are) responsible for announcing the change in state of the link to other nodes in the network. Each segment head end may be arranged to associate the link fault against any path segments for which it acts as a segment head end. If the link impacts one or more of these path segments, the segment head end is responsible for redirecting the LSP data over alternate paths.

A downstream failure may be transmitted in a number of ways, including standard OSPF (Open Shortest Path First Protocol) LSA's (Link State Advertisement) or MPLS path tear signals sent in the upstream direction. To address this issue appropriately, an extension is preferably made to the path tear message. The explicit route that has just failed is added to the path tear message thus informing the path segment head end of exactly which link(s) are under fault and thus which parts of the primary path to redirect around.

A downstream failure may be transmitted by a fast flooding LSA mechanism as described in copending U.S. Patent Application No. 60/290,386, filed on May 14, 2001. A fast flooding mechanism is initiated by the node local to the fault upon failure detection. This node and all other nodes in the network forward the link state advertisement (LSA) preferably at wire speed with minimal per-hop delay.

Although either of the first two previously mentioned approaches will suffice, the recommended approach is to use the fast LSA flooding mechanism to inform all nodes of the failure event. This improves scalability by informing all nodes in the network of the fault. Each node can then determine simultaneously if it acts in a path segment head end role for any paths running over the link(s) that has failed.

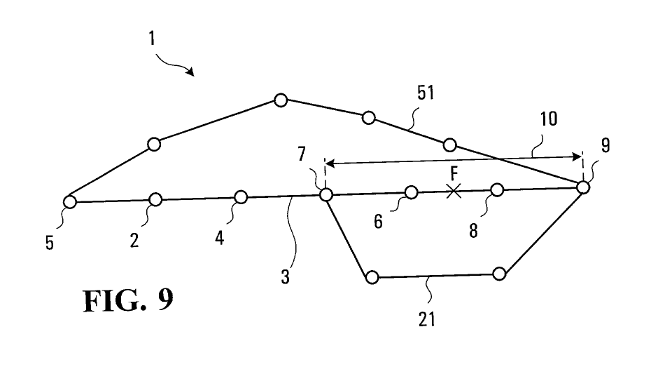

Although in a preferred embodiment, the or each segment head switching router responsible for a particular segment of the plurality communication path is adapted to respond directly to a fault on the segment for which it is responsible, in another embodiment, the communication network may be arranged such that a fault indication is relayed to one or more switching routers other than the segment head switching router responsible for the section on which the fault occurs. The fault condition is interpreted by one or more other switching routers which subsequently signal the segment head switching router to establish a secondary communication path around the fault, if necessary, and to re-route data from the primary communication path to the secondary communication path. An example of an embodiment of such a communication network is shown in FIG. 9. This communication network is similar to that shown in FIG. 1, and like parts are designated by the same reference numerals.

Referring to FIG. 9, a communication network 1 comprises a first communication path 3 which includes first, second and third switching routers 5, 7, 9 and a second communication path 21 extending from the second switching router 7 to the third switching router 9. The communication network further comprises a third communication path 51 extending from the first switching router 5 to the third switching router 9. The first switching router 5 may be the source node or an intermediate node of the first communication path. In this embodiment, when a fault, F, occurs on the section 10 of the primary path between the second and third switching routers 7, 9, the fault is detected by one or both of switching routers 6, 8 which are nearest the fault, at least one of which is arranged to forward an indication of the fault to the first switching router 5 along the third communication path 51. On receiving the fault indication, the first switching router 5 determines the segment head from which data should be diverted from the first communication path onto an alternative path and transmits an appropriate signal to the second switching router to perform the required switching, and if necessary, establish a secondary path around the fault.

Secondary Path Selection

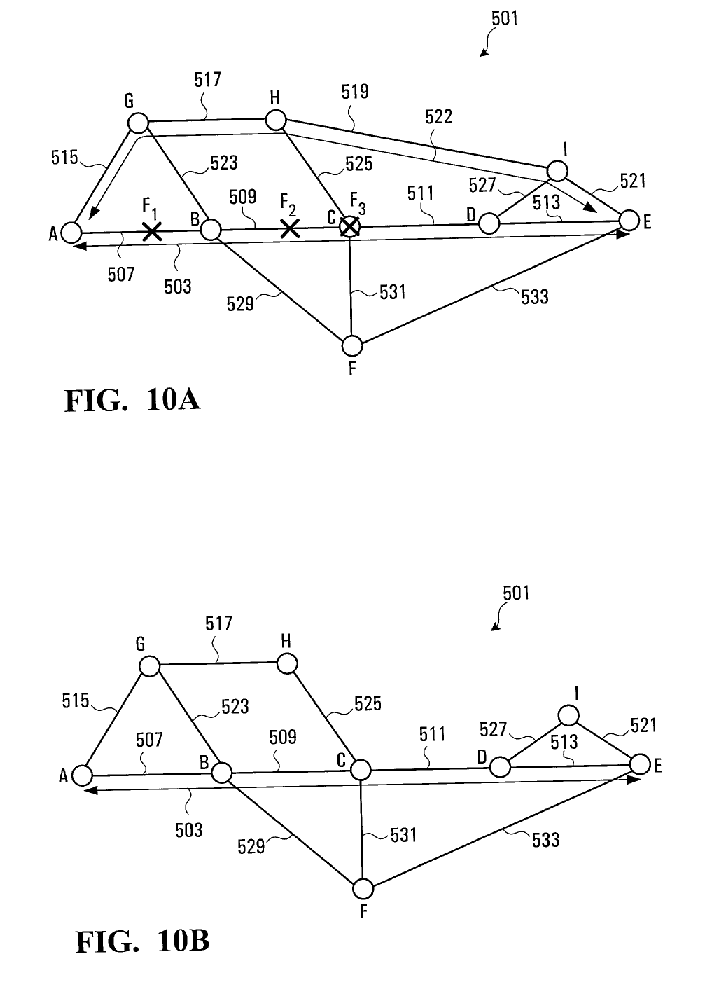

For the purpose of protecting the primary or working path, it is desirable to select a secondary path which shares as few resources, i.e. nodes and links with the part of the primary path being protected, as possible. In this case, the secondary path may be described as “maximally disjoint” from the primary path. Preferably, a secondary path is selected which shares no resources with the part of the primary path being protected, if such an alternative path exists. If no such path exists, a secondary path may be selected, depending on the relative risk associated with each shared resource of the primary path. In one embodiment, a secondary path may be selected which shares the minimum number of links with the primary path. A secondary path which shares no links with the primary path may be referred to as “link disjoint”. In another embodiment, a secondary path may be selected which shares the least number of nodes with the primary path. A secondary path which shares no nodes with a primary path may be referred to as “node disjoint”. An example of a communication network having a plurality of different possible secondary paths is shown in FIG. 10A.

Referring to FIG. 10A, a communication network, generally shown at 501, includes a primary communication path 503 having a series of nodes A, B, C, D and E and interconnecting communication links 507, 509, 511, 513. The primary path may comprise a section of a communication path between a source node (e.g. ingress LER) and a destination node (e.g. egress LER), and node A may comprise a source or intermediate node, and node E may comprise an intermediate or destination node of the communication path. The communication network 501 further comprises a plurality of further nodes, F, G, H, and I and communication links 515 to 533 forming a plurality of alternative communication paths between nodes A and E. Using the above selection criteria, the alternative path which is to protect the primary path between nodes A and E is selected such that it shares the minimum number of nodes and links with the primary path. In this embodiment, an alternative path exists which shares no intermediate nodes or communication links with the primary path between nodes A and E, namely the communication path 522 defined by nodes A, G, H, I and E and communication links 515, 517, 519 and 521. Since all the other possible alternative paths share at least one resource with the primary path, this alternative path is maximally disjoint from the primary path and is therefore preferably selected to protect the primary path between nodes A and E.

In this embodiment, node A may be selected to function as the segment head of the primary path between nodes A and E and may be conditioned or configured to direct data packets for transmission over the primary path onto the selected secondary path defined by nodes A, G, H, I, and E, in response to a fault on the primary path between nodes A and E. In one embodiment, a secondary label switched path is established between nodes A and E, and the switching router of node A is adapted to direct data on to the secondary LSP by outputting data packets with the first forwarding label defining the secondary LSP onto the first communication link 515 of the secondary path. The switching router of node A may be configured to select and/or establish the secondary communication path, or the selection and establishment of the secondary communication path may be managed from or by another node or resource of the communication network.

In another embodiment, the switching router at node A may be pre-configured (e.g. by configuring one or more Incoming Label Maps (ILM'S)) to protect the primary path and invoke one of a plurality of secondary paths contingent on which resource or resources of the primary path fail. For example, referring again to FIG. 10A, a first protection path defined by nodes A, G, and B may be established and invoked to re-route data intended for transmission along the primary path between nodes A and B, in the event of a failure F₁ on link 507 between nodes A and B. In this case, node B is adapted to merge or route data received from the protection path back onto the primary path to node C. A second protection path defined by nodes A, B, F and C, may be established and invoked to restore data transmission in the case of a failure F₂ associated with link 509 between nodes B and C of the primary path. In this case, node C is adapted to merge or route data intended for transmission over the primary path between nodes B and C back onto the primary path to node D.

A third protection path, for example defined by the nodes A, B, F and E, may be established and invoked to restore data transmission in the event of a failure F₃ of network node C.

In each case, a switching router at node A may store the necessary instruction(s), ie. forwarding tables or ILM(s), required to re-direct data over the appropriate protection path in response to a fault or failure indication which also indicates the particular resource(s) of the primary path that has failed. The switching router of node A may also be conditioned to establish each alternative protection path.

In a case of restoration, where the secondary path is established after the occurrence of a failure on the primary path, either on an alternative path which is maximally disjoint from the primary path between nodes A and E may be established or an alternative path which shares at least one resource with the primary path and which bypasses the failed resource or resources may be established. The switching router at node A may be configured to implement at least one of these restoration schemes. Thus, for example, in implementing a maximally disjoint LSP, the switching router at node A may be conditioned to establish the appropriate secondary LSP in response to a fault or failure of any of the resources of the primary path between nodes A and E.

In another embodiment, the switching router at node A is conditioned to respond to a fault indication which specifies a particular resource or resources which have failed by discovering an alternative path which bypasses the failed resource(s), and at the same time includes one or more active (unfailed) resources of the primary path. In one embodiment, the segment head switching router at node A may be conditioned to discover a plurality of alternative paths around the failed resource, measure or determine the value of a parameter describing each alternative path, and select an alternative path based on its determination of the values of the parameter for each alternative path. For example, the segment head switching router may be adapted to select the shortest or least expensive alternative path. The switching router of node A may be adapted to respond to each of the faults F₁, F₂ or F₃ in the manner described above in connection with protection of the primary path.

FIG. 10B shows another embodiment of a communication network, which is similar to the communication network shown in FIG. 10A, except that in FIG. 10B, the communication link 519 between nodes H and I does not exist. In this case, all of the possible alternative paths for protection and restoration of the primary path necessarily share at least one resource with the primary path. A first example of an alternative path between nodes A and E is defined by nodes A, G, H, C, D, I and E, and exemplifies a path which shares a link 511, and two nodes C and D with the primary path. A second example of an alternative path is defined by nodes A, G, B, F and E, and a third example is defined by nodes E, G, H, C, F and E. In both cases, the alternative path shares a single node (i.e. node B or C, respectively) with the primary path and no communication links and, are therefore both “link disjoint”. For protection, the secondary path may be selected for example from the above three possible alternative communication paths on the basis of one or more selection criteria, which may include the number of resources shared with the secondary path, the relative risk of failure of each resource, the path link transmission characteristics and capacity and the path cost. These and any other criteria may be applied in any order and with any priority. If the most important criteria is to minimize the number of shared resources with the primary path, either the second or third alternative paths may be selected which share only one resource with the primary path. The selection between the second and third alternative paths may then depend on other criteria, for example path length or cost, the relative costs of nodes B and C, their connectivity to the network, their relative risk of failure and the spare capacity of the alternate paths.

Segment Head Selection

Another aspect of the present invention is concerned with methods of selecting one or more segment head nodes along the network path (i.e. primary or working path) to improve or optimize the handling of a resource failure.

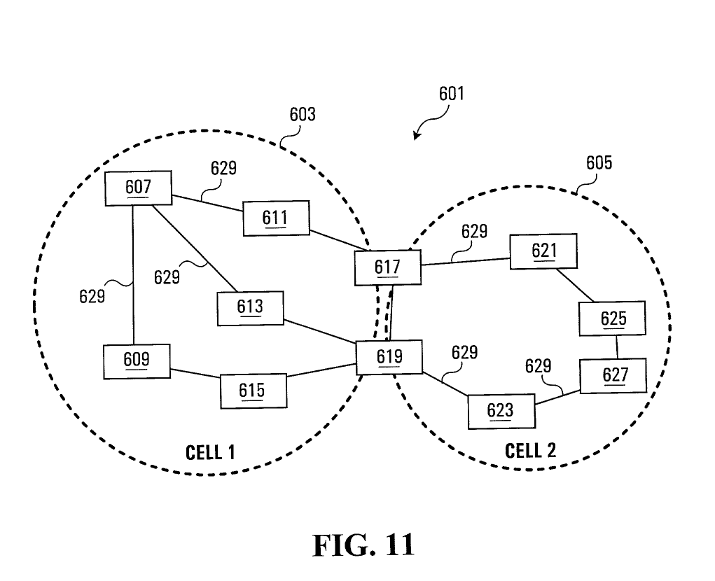

The selection of one or more segment heads may be based in part by the way the network is planned. For example, a network may be divided into a number of cells, and one or more nodes at the interface of each cell may be selected to function as a segment head node for the purpose of protection and/or restoration. An example of a network which is subdivided into a plurality of areas or cells as shown in FIG. 11, and will be described with reference to an optical network.

Referring to FIG. 11, an optical network generally shown at 601 is divided into optically isolated areas or cells 603, 605. Each optical cell includes a number of nodes 607 to 627 connected by optical fibre communication links 629 in a pre-defined manner, preferably to provide route diversity to each node. This division may be required for network planning and scalability so that one area of the network can be wavelength planned, or scaled without impacting the wavelength colouring solution within another area of the network.

For a network incorporating optical cells, candidate segment heads can be designated throughout the network at the boundaries of the optical cells. For example, in the embodiments shown in FIG. 11, network nodes 617 and 619 at the boundary between the first and second cells 603, 605 may be selected to serve as segment head nodes for communication paths which pass from one cell to an adjacent cell. This selection criteria closely matches with the properties of the optical cells. In another embodiment, segment heads can be chosen using any other criteria, including those described below in connection with an arbitrary network.

Segments in Arbitrary Networks

In arbitrary networks, there are many ways to determine which nodes should act as segment head nodes. A particular segment head may be selected to serve as a segment head for one or more selected LSP's on the primary path, and where a plurality of LSP's are established on the primary path, each LSP may have one or more different segment heads. As new LSP's are established, the segment head for a particular LSP may be predefined, or may be established dynamically for that particular LSP.

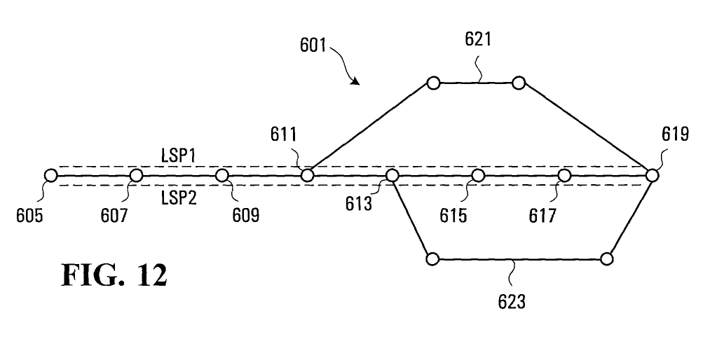

An example of an embodiment in which different segment heads are selected for different LSP's on the primary path is shown in FIG. 12. Referring to FIG. 12, a communication network 601 includes a primary path 603 having a plurality of nodes 605 to 619. First and second label switched paths LSP1 and LSP2 are established on the primary path 603. The communication network further includes a first secondary path 621 extending between the fourth and eighth nodes 611, 619 and a second secondary path 623 extending between the fifth and eighth node 613, 619. In this example, the fourth node is selected to serve as the segment head node for the first LSP, LSP1 and is responsible for directing data traffic from the primary path onto the first secondary path 621 in the event of a fault on the primary path segment between itself and the destination node 619. The fifth node 613 is selected to serve as the segment head node for the second LSP, LSP2 and is responsible for re-directing data traffic from the primary path onto the second secondary path 623 in the event of a fault on the primary path between itself and the destination node 619.

Embodiments of methods for selecting one or more segment head nodes in communication networks will now be described below.

In one embodiment, a segment head node may be selected on the basis of the number of intermediate nodes between the source and destination nodes and a segment head node may be selected as a node which is substantially equidistant between the source and destination nodes (i.e. a median node), or a segment head node may be selected at every certain number of nodes along the primary path between the source and destination nodes. Thus, at one extreme, a single intermediate segment head node may be selected between the source and destination nodes, and at the other extreme, every node between the source and destination nodes may be selected to serve as a segment head node.

Another selection criteria which may be used to select a segment head, is to select those nodes that divide the path into predetermined segment lengths.

Another selection criteria is to select the or each segment head such that the transmission delay between the source node and the segment head and the segment head and the destination node and between each intermediate segment head is substantially the same or as even as possible, or in other words so that any difference between the transmission delays in the path segments is minimized. Transmission delays are generally attributable to both links and nodes. Link delay is generally dependent on the propagation characteristics of the link, and node delay may be dependent on the level of node congestion or activity. Advantageously, this selection of criteria assists in minimizing improvements in the protection and restoration time since it can limit the maximum time delay between the occurrence of a fault and receipt of a fault indication by a segment head node.

Where a plurality of candidate nodes exist for a particular segment head node, the segment head may be selected depending on a parameter defining the connectivity from each of the candidate nodes to the alternative path. For example, the segment head node may be chosen as the node which connects to the secondary path with minimum cost or connects to the secondary path with minimum propagation delay and/or via the shortest route, or may be selected as the node which has the highest degree of connectivity and is therefore most likely to find one or more alternate routes.

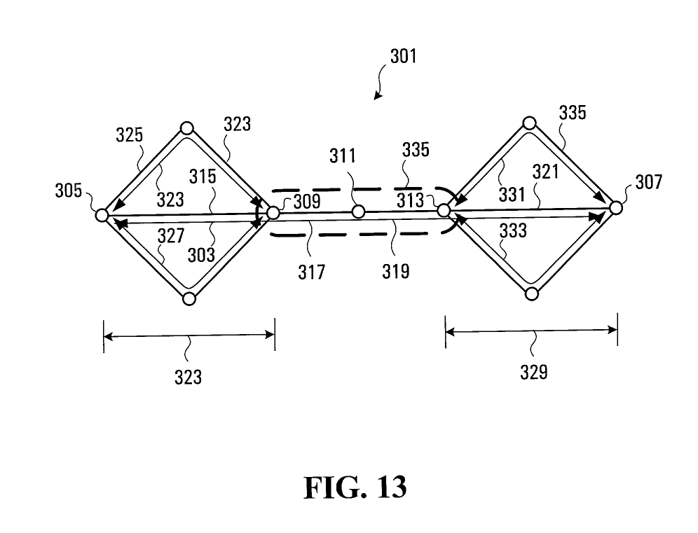

Another criteria which may be applied in selecting a segment head is to avoid those nodes with a high level of congestion or risk or any nodes which are deemed to be a critical resource, for example a node on an edge of a bridge link, which is a set of nodes that provides the only connectivity between two parts of a network. An example of a bridge link is shown in FIG. 13. FIG. 13 shows a communication network 301 which includes a first communication path 303 having a source and destination nodes 305, 307 and intermediate nodes 309, 311, 313 and communication links 315, 317, 319 and 321. The communication network includes a first section 323 having alternate paths 235, 237 extending from the source node 305 to the first intermediate node 309 and a second section 329 having alternative communication paths 331, 333 extending between the third intermediate node 313 and the destination node 307. In this example, the only path which joins the nodes of the first and second sections of the network extends between the first and third intermediate nodes 309, 313, and this path constitutes a bridge link 335 (shown by the dotted lines), of which the first and third intermediate nodes are located on the edge of the bridge link. In segmenting the primary path 303 for protection or restoration and selecting a node to serve as a segment head node for a section of the primary path between itself and the destination node, neither of the first and second intermediate nodes 309, 311 are particularly suitable candidates since neither have any access or connectivity to a secondary path which could bypass a fault on the primary. However, the third intermediate node 313 on the edge of the bridge link at the second section 329 of the network has access to alternative paths 331, 333 between itself and the destination node 307 and could therefore serve as a suitable segment head for the section of the primary path between itself and the destination node 307. In this example, the source node could serve as the segment head node for the section of the primary path between itself and the first intermediate node 309. However, the part of the primary path defined by the bridge link 335 cannot be protected by a secondary path, as the bridge link is the only communication link connecting the first and second sections of the network.

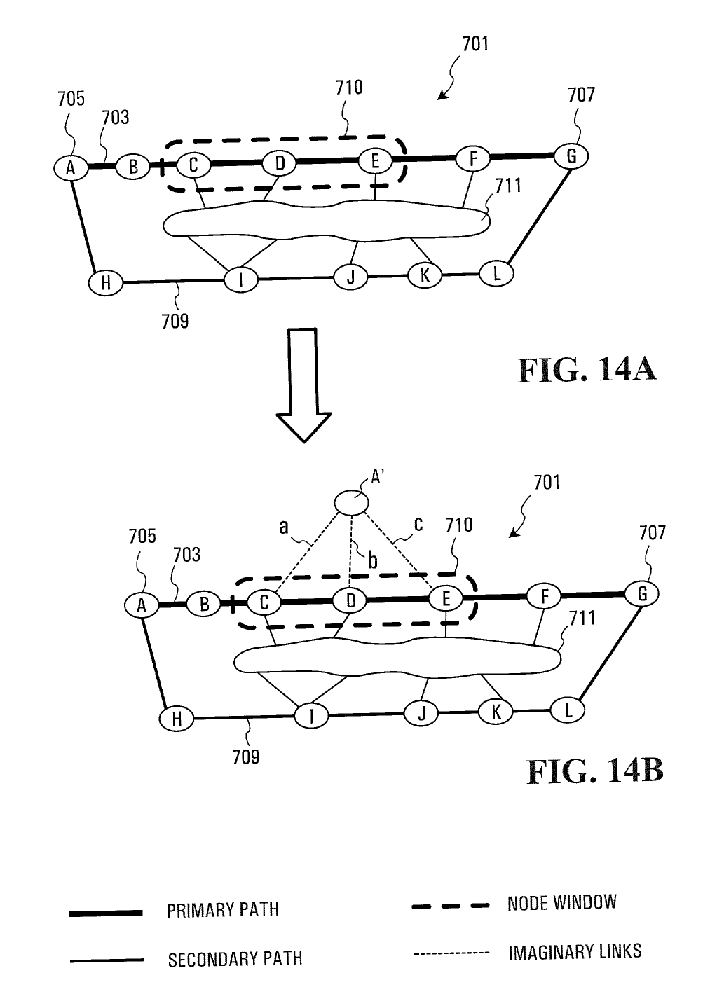

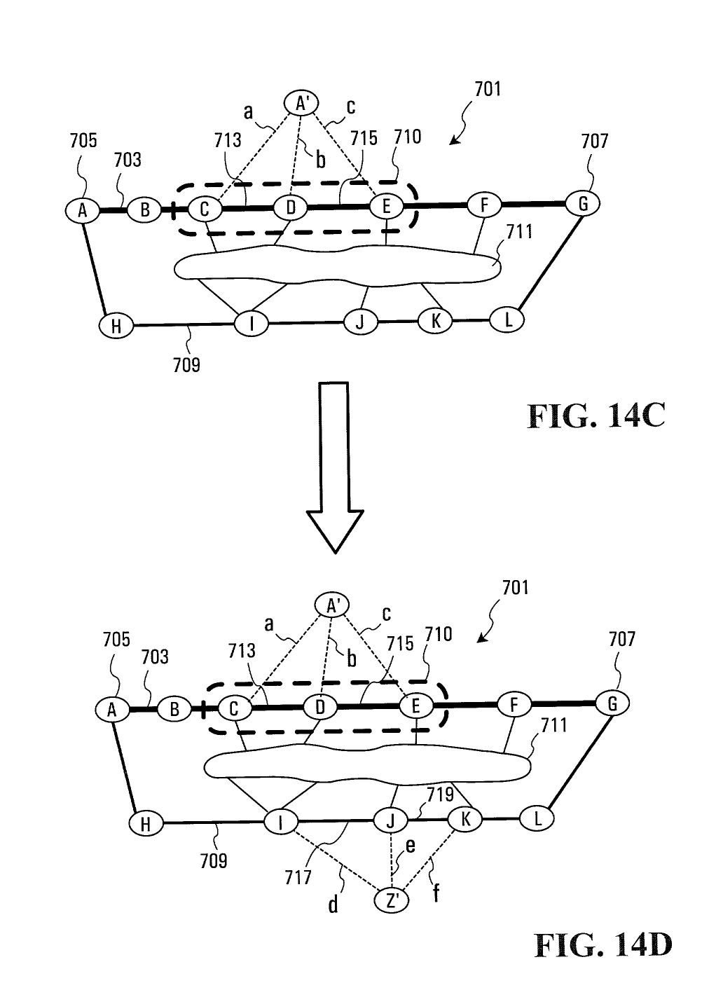

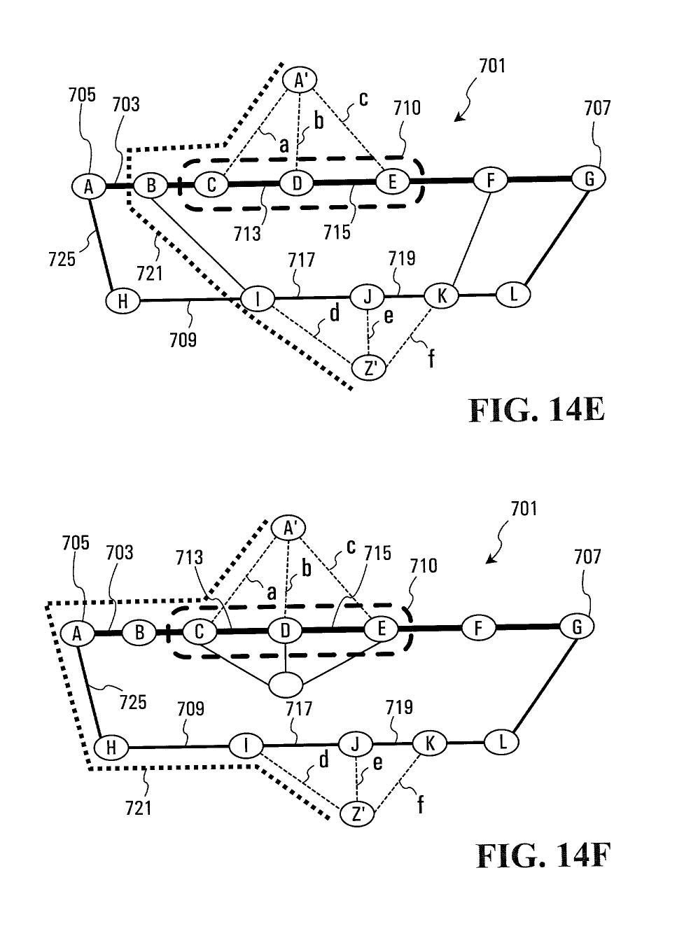

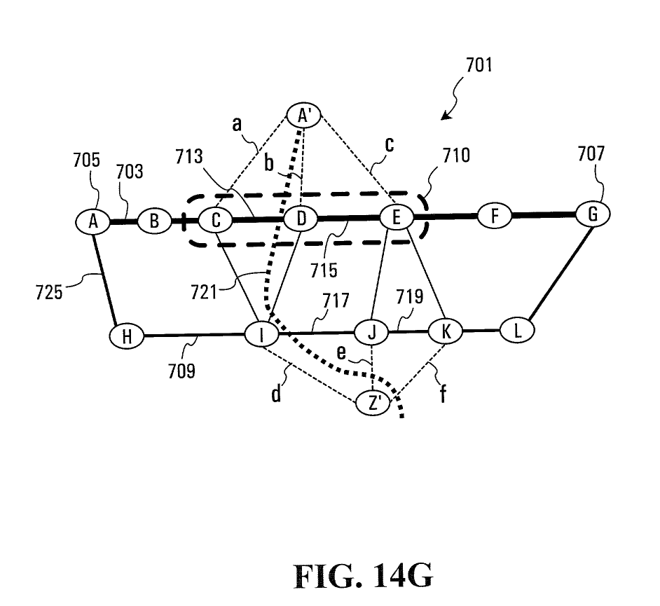

Examples of methods of evaluating and selecting a segment head in accordance with embodiments of the present invention will now be described with now be described with reference to FIGS. 14A to 14G.

FIG. 14a shows an example of a communication network, generally shown at 701, which includes a primary path 703 having source and destination nodes 705, 707, labelled A and G. The primary path 703 further includes a plurality of intermediate nodes B, C, D, E, and F. The communication network 701 includes a secondary communication path 709 extending from the source node 705 to the destination node 707 of the primary communication path. The secondary communication path has a plurality of intermediate nodes H, I, J, K, and L. In this embodiment, a number of intermediate nodes C, D, E, F of the primary path are connected to a number of intermediate nodes I, J, K of the secondary path through various network links represented by an intermediate network cloud 711.

In this example, an objective is to divide the primary path 703 into two segments for the purpose of protection and/or restoration and to select an intermediate node to serve as the segment head node of the second segment between that node and the destination node G according to predetermined criteria. It is to be noted that this method can be applied to select a plurality of segment head nodes each from a plurality of candidate intermediate nodes (test nodes), for example where the communication path is to be divided into three or more segments.

In the present example, a first step of the method involves selecting a plurality of candidate intermediate nodes (test nodes) on the primary path which could serve as the intermediate segment head node. The candidate nodes may be selected in accordance with one or more predetermined criteria, including any of the criteria described above. In this example, a plurality of intermediate nodes C, D and E shown within the dashed window 710 are selected at or near the median of the primary path between the source and destination nodes so that each segment will be approximately the same length. The selection criteria may also provide that the data propagation time across each segment is approximately the same. Candidate nodes on the primary path may be selected only if their degree of connectivity is three or more.

Once a plurality of test nodes on the primary path have been selected, a parameter describing their relationship to the secondary path is evaluated. In one example, this parameter is the physical length of a test path between a test node on the primary path and a node on the secondary path. Once the physical length of each test path has been determined, the test node of the primary path which is connected to a node on the secondary path by the shortest test path may be selected. In other examples, the parameter may comprise a parameter which describes the propagation time between a test node on the primary path and a test node on the secondary path, for example an actual value of the propagation time, the number of nodes on the test path, the characteristics of the nodes on the test path and the propagation characteristics of the communication links on the test path.

An embodiment of a method for evaluating and selecting one or more nodes to serve as segment head nodes, and which may conveniently be implemented by a computer program will now be described with reference to 14B to 14G.

As shown in FIG. 14B, the primary path is transformed by adding an imaginary node A′, and attaching an imaginary link a, b, c from each test node C, D, and E to the imaginary node A′. A parameter is selected which describes the relationship between a test node on the primary path and a test node on the secondary path (e.g. test path link) which is to be evaluated and used to determine which test node to use as the segment head node on the primary path. A value of this parameter is assigned to each of the imaginary links a, b, and c which is preferably the same value for each imaginary link and may be set to zero or any other suitable value.

To evaluate the relationship between each test node of the primary path with a plurality of test nodes on the secondary path, a plurality of secondary path test nodes I, J, K are selected, preferably having a degree of connectivity of at least three. As shown in FIGS. 14C and 14D the secondary path 709 is transformed by adding an imaginary node Z′ and adding an imaginary link d, e, f from each test node I, J and K on the secondary path to imaginary node Z′. A value of the selected parameter used to describe a test path between the primary and secondary paths is assigned to each of the imaginary paths d, e, f and is preferably the same value for each of the imaginary paths d, e and f, and may be set to zero or another suitable value.

The next step in the method is to determine the value of the selected parameter for a plurality of possible paths between the two imaginary nodes A′ and Z′. The values of the parameter determined for each path may then be compared with one another or with a target value and the path having the desired value then selected. For example, the parameter may comprise path length and the method determines the path length for each of a plurality of paths from imaginary nodes A′ to Z′ which pass through at least one of the test nodes on the primary path and at least one test node on the secondary path, and selects the path with the shortest path length.

Before evaluating the value of the selected parameter for each path between the imaginary nodes, one or more links 713, 715 between adjacent test nodes on the primary path and/or one or more links 717, 719 between adjacent test nodes on the secondary path may be assigned a value of the selected parameter such that the paths between the imaginary nodes for which the value of the selected parameter is determined excludes those paths which might otherwise include a link between adjacent nodes on the primary and/or secondary paths.

Once the path having the desired value of the selected parameter has been determined, the path is examined and the test node which is to serve as the segment head node is selected. In the determination of a feasible segment head node, the following criteria may be applied.

If the determined path traverses a primary path node which is not one of the selected test nodes, any one of the test nodes, for example the node closest to the median, may be selected as the segment head node and arranged to direct data onto the secondary path, in response to a fault on the primary path downstream thereof, either via the source node or via the primary path node which is connected to the secondary path. An example of this scenario is illustrated in FIG. 14E. In this example, the determined path 721 (shown by the dotted line) between the imaginary nodes A′ and Z′ passes through intermediate nodes C and B of the primary path, and intermediate node I of the secondary path 709 via communication link 723. In this case, any one of intermediate nodes C, D, or E of the primary path may be selected as the segment head node. For protection or restoration of the segment between the selected intermediate segment head and the destination node G, the intermediate segment head node may be arranged to direct data back to intermediate node B which then routes data onto the secondary path over communication link 723, or to direct data back to the source node A, which may be arranged to route data to node H of the secondary path via communication link 725.

If the determined path traverses either the source or destination nodes, as for example in the case of a ring network, any one of the test nodes, for example the node closest to the median, on the primary path may be selected to serve as the segment head node between that node and the destination node. For protection and/or restoration, the selected segment head node is adapted to direct data back to the source node which subsequently directs the data onto the secondary path. An example of this scenario is illustrated in FIG. 14F. In this example, the determined path 721 shown by the dotted line extending between the imaginary nodes A′ and Z′ passes through the source node A. In this case, any one of the test nodes C, D and E may be selected as the segment head node, and for protection and/or restoration, may be adapted to route data back to the source node which subsequently routes data onto the secondary path via communication link 725.

If the primary path node(s) through which the determined path between the imaginary nodes A′ and Z′ passes only includes one or more of the selected test nodes, then one of the test nodes on the primary path may be selected to serve as the segment head node. An example of this scenario is illustrated in FIG. 14G. In this example, the determined path 721 between the imaginary nodes A′ and Z′ traverses one test node D on the primary path and one test node I on the secondary path. In this case, intermediate test node D is preferably selected as the segment node for the purpose of protection and restoration of the segment between the intermediate node D and the destination node G.

The segment head end of each segment may be selected at the original label edge router (LER) before the path is signalled. The LER of the path may select the segment head ends for the path to be established. The segment head end may be signalled, via an explicit route object (ERO), or other signal, indicating that the appropriate node should act as a segment head end for the path. The or each head end node is conditioned to manage path restoration in the event of a failure within its segment of the primary path.

If on selection of a segment head end, an alternate path cannot be established, the segment head end may be arranged to inform the LSP head end of the failure to establish an alternate path. Depending upon when the alternate set-up error has occurred, the source of the path may be signalled of the failure via a path tear or path signal error.

In order to be resilient to failures along the primary path, an alternate path is determined and created and this alternate path merges again with the primary path either upstream of the Egress LER (destination node) or at the destination node. As mentioned above, two basic types of resiliency are possible and it is to be noted that both may be implemented in the same system and may work side by side without interference.

A first level of resiliency to faults or failures is provided by protection of the primary path. In this case, the alternate path which works around any problems in the primary path is pre-computed and preselected. In one embodiment, the path segment head end performs routing on its understanding of the network topology to determine a route that is preferably maximally disjoint from the primary route through the segment. In the case of a pre-computation of the alternate path (LSP), the alternate LSP must merge with the primary LSP somewhere outside the path segment being protected. With this approach, the alternate path is routed and set up prior to fault occurrence. The protection path preferably meets at least the same requirements, e.g. data transmission capacity and/or transmission time, as the segment of the primary path which it protects, although in other embodiments, the protection path may have a lower specification than the primary path. The protection path may be dedicated, in which case it only carries data for transmission on the primary path, or the protection path may carry other data traffic, for example traffic with a lower priority. If the protection path is dedicated, the protection path may be used to carry primary path data traffic only in response to a fault on the primary path, or the segment head node may be arranged to duplicate primary path data and forward the data over both the primary path and the secondary path. In this arrangement, in the event of a fault or failure on the primary path, primary path traffic which may be lost as a result of the fault or failure still continues over the protection path. The node or switching router which normally receives data from both the primary and secondary paths is adapted to select the data traffic transmitted over the secondary path for continued transmission, in response to a fault or failure on the primary path. Advantageously, a protection scheme generally provides the fastest fault recovery times.

A second level of resiliency to faults or failures is provided by restoration or re-connect of primary path data transmission. In this case, the alternate path is routed at the fault detection time. Since in a preferred embodiment, the path segment head node knows the hops along the primary path that have been impacted, a new route can be calculated or determined to re-route traffic from the path segment head end and back onto the primary LSP without using the link(s) that have failed. In this case, the alternate LSP must merge with the primary LSP but this merge can occur within the path segment under recovery.

If the path segment head ends line up to cell boundaries, then the alternate route can be calculated from a reduced topology which includes those nodes and links in the cell. Calculating an alternate route is generally faster with a reduced topology. This is one preferred method of path segment head end selection for those paths that require restoration at fault detect time. In another embodiment, the alternate route can be determined from a full view of the network. For example, this method could be imposed in the case where the path segment head end is selected arbitrarily as described above in the section: Segments in Arbitrary Networks. Although the route determination in this case will generally be slower than in the cell-based approach, the alternate route will still be correct and valid.

The step of establishing a path is generally the same whether the alternate path is established prior to fault occurrence or after fault occurrence. In one embodiment, the alternate LSP is signalled as a normal LSP with an attribute that has significance at the merge point. At the merge point, (where the alternate and primary LSP's meet up again) the alternate LSP may indicate the LSP with which it will be merged (which is a primary LSP). The merge may be controlled by the replacement of multiple incoming labels for example the replacement of labels for the alternate and primary LSP's with a single outgoing label, for example that of the primary LSP. It is possible to extend the standard merge concept to allow the path segment head end to signal the explicit routing of an incoming LSP onto an outgoing LSP.

Generally, in the event of a failure, a path segment head end redirects the incoming LSP onto an alternate LSP. This alternate LSP merges with the primary LSP at some point down the stream for failure. The LSP merge insures that the data is forwarded correctly to the Egress LER.

Each path segment is assigned one or more segment heads. The segment head(s) may be responsible for (1) setting up and managing alternate paths within a cell or segment area, and are generally responsible for (2) acting on failure indications, and (3) switching traffic over to the restoration path on failure.

The segment head may be signalled to act as a segment head for a particular flow, e.g. LSP. The segment head may then discover alternate diverse routes within its segment to satisfy the protection/restoration requirements of the flow. This process also distributes the memory requirements of the source node between itself and the other segment heads.

When the segment head receives a failure indication, it will attempt to recover the traffic. If the only backup route available is already used, the error may be propagated back to the source node for further processing.

Embodiments of the invention described herein provide systems which attempt to optimize the completion time of protection and restoration schemes in large arbitrary networks. Generally, a network path is divided into two or more segments, depending on its size, with the start of each segment assigned the responsibilities of a segment head. Each segment head is generally responsible for servicing its portion of the path.

Modifications, changes and alternatives to the embodiments described above will be apparent to those skilled in the art.

1. A communication network including a first communication path having a plurality of switching routers, a second communication path having at least one communication path element different from said first communication path and extending from a selected one of said switching routers to a position on said first communication path located at a distance from said selected switching router of less than the length of said first communication path, wherein said selected switching router includes output means for outputting data with a label for routing data along one of said first and second communication paths, and routing means responsive to a fault in the transmission capability of said first communication path between said selected switching router and said position for routing data received by said selected switching router for transmission along said first communication path, along said second communication path.

2. A communication network as claimed in claim 1, wherein said first communication path includes a first switching router, a second switching router downstream of said first switching router, and a third switching router downstream of said second switching router, and said selected switching router comprises said second switching router.

3. A communication network as claimed in claim 2, wherein said second switching router includes enabling means for enabling said routing means to output data specified for transmission on said first communication path, onto said second communication path with a label for routing said data along said second communication path.

4. A communication network as claimed in claim 3, wherein said enabling means comprises a machine readable instruction.

5. A communication network as claimed in claim 4, wherein said second switching router comprises a memory storing said machine readable instruction.

6. A communication network as claimed in claim 3, wherein said second switching router is configured to read a label associated with received data and to identify therefrom data specified for transmission on said first communication path.

7. A communication network as claimed in claim 2, wherein said second switching router further comprises label switched path establishing means for establishing a label switched path on said second communication path for carrying data specified for transmission on said first communication path.

8. A communication network as claimed in claim 7, wherein said label switched path establishing means is adapted to establish said label switched path in response to a fault in the transmission capability of said first communication path.

9. A communication network as claimed in claim 2, further comprising secondary path determining means responsive to the location of a fault on the first communication path for determining said second communication path to bypass said location.

10. A communication network as claimed in claim 9, wherein said path determining means includes selection means for selecting said second communication path from a plurality of communication paths.

11. A communication network as claimed in claim 10, wherein said selection means is adapted to select as said second communication path, the path having the shortest data transmission time.

12. A communication network as claimed in claim 2, wherein said second switching router further comprises secondary path determining means for discovering at least one secondary path.

13. A communication network as claimed in claim 12, wherein said determining means is adapted to determine the value of a parameter defining the or each second communication path.

14. A communication network as claimed in claim 13, wherein said determining means is adapted to select a secondary path based on the determined value(s) of said parameter.

15. A communication network as claimed in claim 14, wherein said parameter is the data transmission time over the secondary path, and the selection means is adapted to select as said second communication path, the path having the shortest data transmission time.

16. A communication network as claimed in claim 12, wherein said second switching router further includes signalling means for signalling said first switching router if said second switching router fails to determine a second communication path.

17. A communication network as claimed in claim 16, wherein said first switching router is adapted to determine an alternative path which bypasses said location in response to said signal.

18. A communication network as claimed in claim 17, wherein said first switching router is adapted to establish a second label switched path over said alternative path and direct data specified for transmission on said first communication path onto said second label switched path.

19. A communication network as claimed in claim 2, wherein said first communication path includes a plurality of intermediate switching routers between said first switching router and said third switching router, a first label switched path is established on said first communication path which originates at said first switching router and terminates at said third switching router, and wherein said second switching router is selected from said plurality of intermediate switching routers as the switching router such that the difference in the transmission time on each section of the first communication path between itself and the first switching router and itself and the third switching router is a minimum.

20. A communication network as claimed in claim 2 comprising a plurality of intermediate switching routers between said first and third switching routers, a first label switched path established on said first communication path which originates at said first switching router and terminates at said third switching router, said intermediate switching routers including a plurality of said selected switching routers, each having a second communication path extending therefrom to a position on said first communication path located at a distance from a respective selected switching router of less than the length of said first communication path, and wherein the selected switching routers are selected from said plurality of intermediate switching routers such that any difference in the data transmission time on each section of the first communication path between each pair of neighbouring selected switching routers is a minimum.

21. A communication network as claimed in claim 1, wherein said second communication path is selected to share the minimum number of communication links with said first communication path.

22. A communication network as claimed in claim 17, wherein said second communication path is selected to share the minimum number of switching routers with said first communication path.

23. A communication network as claimed in claim 2, comprising a plurality of intermediate switching routers between said first switching router and said third switching router, each being connected to said second communication path by a respective intermediate communication path, and wherein said selected switching router is that which is connected to said second communication path by the intermediate communication path having the shortest data transmission time.

24. A communication network as claimed in claim 2, further comprising a fault detector for detecting a fault on the first communication path and transmitting a signal indicating the presence of said fault to said second switching router.

25. A communication network as claimed as claimed in claim 24, wherein said fault detector further includes means for detecting the location of said fault and transmitting a signal to at least one of said first and second switching routers indicating at least one of the location of said fault and the element of said first communication path at which said fault is located.

26. A communication network as claimed in claim 2, wherein said second switching router includes enabling means for enabling said routing means to output data specified for transmission on said first communication path, onto said first communication path with a label for routing said data along said first communication path.

27. A communication network as claimed in claim 2, comprising a label switched path on said first communication path which originates at said first switching router and terminates at said third switching router, and wherein the length of said label switched path defines the length of said first communication path.

28. A communication network as claimed in claim 2, comprising an intermediate switching router between said second switching router and said third switching router, said second communication path adjoining said first communication path at said intermediate switching router, and wherein said intermediate switching router includes enabling means for enabling said intermediate switching router to direct data received on said second communication path intended for transmission on said first communication path onto said first communication path.

29. A communication network as claimed in claim 28, comprising a label switched path established on said first communication path, and wherein said intermediate switching router is adapted to label data received from said second communication path intended for transmission on said first communication path with a label defining said label switched path on said first communication path.

30. A communication network as claimed in claim 1, wherein said first communication path includes a first switching router, a second switching router downstream of said first switching router and a third switching router downstream of said second switching router, and wherein said a second communication path extends from said second switching router to a predetermined point on said first communication path downstream of said second switching router, said second switching router being adapted to route data over said first communication path in response to a predetermined label associated with said data, and having re-routing means responsive to a fault condition in the transmission capability of said first communication path between said second switching router and said predetermined point for re-routing data received by said second switching router from said first switching router along said second communication path.

31. A communication network as claimed in claim 30, wherein said second communication path includes a switching router between said second switching router and said predetermined point, and said switching router of said second communication path is adapted to route data received by said second switching router intended for further transmission along said first communication path to said third switching router, along said second communication path in response to a predetermined label associated with said data.

32. A communication network as claimed in claim 30, wherein said first communication path includes a further switching router between said second switching router and said third switching router, and wherein said second communication path joins said first communication path at said further switching router or downstream of said further switching router.

33. A communication network as claimed in claim 32, further comprising a third communication path between said further switching router and a second predetermined point along said first communication path downstream of said further switching router, and wherein said further switching router includes re-routing means responsive to a fault condition in the data transmission capability of the first communication path between said further switching router and second predetermined point for re-routing data received by said further switching router intended for further transmission along said first communication path to said third switching router, along said third communication path.

34. A communication network as claimed in claim 33, wherein said third communication path includes a switching router between said further switching router and said second predetermined point, and wherein said switching router of said third communication path is adapted to route data along said path in response to a label associated with the data transmitted from said further switching router.

35. A communication network as claimed in claim 30, including a further communication path extending from said first switching router and adjoining said first communication path at a predetermined point downstream of said first switching router, wherein said first switching router includes re-routing means responsive to a fault condition in the transmission capability of said first communication path between said first switching router and said predetermined point at which said further communication path joins said first communication path, for re-routing data intended for transmission along said first communication path, along said further communication path.

36. A communication network as claimed in claim 35, wherein said further communication path includes a switching router between said first switching router and said predetermined point, said switching router being adapted to direct data from received from said first switching router intended for transmission along said first communication path along said further communication path in response to a label communicated with said data by said first switching router.

37. A communication network as claimed in claim 30, wherein said first communication path includes a first switching router, a second switching router downstream of said first switching router and a third switching router downstream of said second switching router, a second communication path extending from said first switching router to said second switching router, said second switching router being adapted to route data over said first communication path in response to a predetermined label associated with said data, and wherein said first switching router includes routing means responsive to a fault condition in the data transmission capability of said first communication path between said first switching router and said second switching router for re-routing data intended for transmission along said first communication path, along said second communication path.

38. A communication network as claimed in claim 37, wherein said second switching router is adapted to route data intended for transmission along said first communication path between said first switching router and said second switching router and received from said second communication path, along said first communication path, downstream thereof.

39. A method of conditioning a communication network to restore data transmission from a source node to a destination node in the event of a fault between an intermediate node and said destination node on a first communication path which includes said source node, said intermediate node and said destination node and defines a first label switched path originating at said source node and terminating at said destination node, the method comprising the steps of establishing a secondary label switched path, originating at said intermediate node, along a second communication path which bypasses said fault and re-joins said first communication path, and conditioning said intermediate node to direct data from said first label switched path to said second label switched path in response to a fault on said first communication path between said intermediate node and said destination node.

40. A method as claimed in claim 39, comprising establishing said second label switched path in response to said fault.

41. A method as claimed in claim 39, comprising establishing said label switched path in response to a signal transmitted from said source node to said intermediate node.

42. A method as claimed in claim 39, comprising a plurality of intermediate nodes between said source node and said destination node, and each connected to said second communication path by a respective intermediate communication path, and establishing said secondary label switched path to originate at the intermediate node which is selected based on the value of a parameter defining at least one of (a) each of said intermediate communication paths, and (b) each of said intermediate nodes.

43. A method as claimed in claim 42, comprising selecting said secondary label switched path to originate at the intermediate node which is connected to said second label switched path by the intermediate communication path having the shortest data transmission time.

44. A method as claimed in claim 43, further comprising determining which of said intermediate communication paths has the shortest data transmission time.

45. A method as claimed in claim 42, comprising determining the values of said parameter.

46. A method as claimed in claim 39, wherein said communication network comprises a plurality of intermediate nodes between said source node and said destination node, a respective second communication path extending from each of said plurality of intermediate nodes, and the method further comprises selecting one of said intermediate nodes and establishing said second label switched path originating at said selected intermediate node.

47. A method as claimed in claim 46, wherein the selected intermediate node is connected to a second communication path having the shortest transmission time.

48. A method as claimed in claim 46, comprising selecting said intermediate node based on the location of a fault on the first communication path.

49. A method of transmitting data specified for transmission on a first communication path between a source node and a destination node in response to a fault on said first communication path, comprising
labelling said data with a label associated with a second communication path which adjoins said first communication path at first and second locations and which bypasses said fault, the distance between said first and second locations being less than the length of said first communication path, and
outputting said labelled data onto said second communication path.

50. A method as claimed in claim 49, further comprising establishing a label switched path on said second communication path and wherein said label comprises a forwarding label of said label switched path.

51. A method as claimed in claim 49, wherein said first location is situated between said source node and said destination node.

52. A method as claimed in claim 50, comprising an intermediate node at said first location, and establishing a label switched path on said second communication path originating at said intermediate node.

53. A method as claimed in claim 50, wherein said second location is situated between said source node and said destination node.

54. A method as claimed in claim 53 comprising an intermediate node at said second location, and directing data intended for transmission on said first communication path and received from said second communication path onto said first communication path at the intermediate switching router at said second location.

55. A method as claimed in claim 54, wherein a first label switched path is established on said first communication path, and said method further comprises labelling said data with a label defining said first label switched path at said intermediate switching router.

56. A method of evaluating a node for re-directing data from a first communication path, having a source node and a destination node, along a second communication path, along a second communication path, comprising the steps of:
selecting a test node on said first communication path between said source node and said destination node and said destination node,
selecting a test node on said second communication path,
determining the value of a parameter of a test path between said test nodes, and evaluating the test node on said first path for re-directing data to said second path based on the determined value of said parameter.

57. A method as claimed in claim 56, further comprising selecting a plurality of test nodes on said first communication path between said source node and said destination node, determining the value of a parameter of a test path from each of said plurality of test nodes on said first communication path to said test node on said second communication path, and selecting one of said plurality of test nodes on said first communication path for redirecting data to said second path based on the values of said parameters.

58. A method as claimed in claim 57, further comprising extending each test path from each of said plurality of test nodes to an imaginary node by a respective imaginary path, and for each of said plurality of test nodes on said first communication path, determining the value of a parameter of said test path from said imaginary node to the test node on said second path, and selecting a node from said plurality of test nodes on said first communication path based on the values of said parameters.

59. A method as claimed in claim 58, further comprising setting equal values of said parameter for each of said imaginary paths.

60. A method as claimed in claim 58, further comprising setting the value of said parameter for each of said portions of said first communication path between adjacent said test nodes on said first communication path at a value which excludes the or each portion from each test path.

61. A method as claimed in claim 57, further comprising selecting a plurality of test nodes on said second communication path and determining the value of a parameter of a test path between each of said plurality of test nodes on said first communication path and each of said plurality of test nodes on said second communication path, and selecting a node for re-directing data to said second communication path from said plurality of test nodes on said first communication path based on the determined values of said parameter.

62. A method as claimed in claim 61, further comprising extending each of said test paths from each of said test nodes on said second communication path to an imaginary node by a respective imaginary path, and for each of said plurality of test nodes on said second communication path, calculating the value of a parameter of the test path from said imaginary node to each of the test nodes on said first communication path, and selecting a node for directing data to said second communication path from said plurality of test nodes on said first communication path based on the values of said parameter.

63. A method as claimed in claim 62, further comprising step of setting substantially equally values of said parameter for each of said imaginary paths.

64. A method as claimed in claim 62, further comprising setting a value of said parameter for the portion of said second path between each adjacent test node on said second communication path such that the or each portion of said second communication path is excluded from each test path.

65. A method as claimed in claim 61, wherein the step of selecting a plurality of test nodes on said second communication path, comprises selecting a plurality of test nodes connected to three or more communication links.

66. A method as claimed in claim 56, wherein said parameter is selected from the group consisting of (a) path length, (b) path cost, (c) path capacity, (d) density of data on the path, (e) the number of nodes on the path and (f) the number of nodes on the path having three or more communication links.

67. A method as claimed in claim 57, further comprising selecting a node for re-directing data to said second communication path from said plurality of test nodes if a test path excludes all nodes on said first communication path other than said plurality of test nodes.

68. A method as claimed in claim 57, comprising selecting a node for re-directing data to said second communication path from one of said source node and one or more other nodes, if any between said source node and the first of said plurality of test nodes on said first communication path if each of said test paths include said source node or one or more of said other nodes or said destination node.

69. A method as claimed in claim 68, comprising selecting said source node as said node for re-directing data to said second communication path if each of said test paths includes said source node or said destination node.

70. A method as claimed in claim 57, further comprising the step of selecting a second communication path from a plurality of communication paths connected to said destination node, such that the selected second communication path shares the minimum number of communication links with the first communication path.

71. A method as claimed in claim 70, comprising selecting said second communication path such that said second communication path shares the minimum number of nodes with said first communication path between said test node on said communication path and said destination and said destination node.

72. A communication network comprising a first communication path having a source node and a destination node and a plurality of intermediate nodes therebetween, a second communication path connected to said destination node, and wherein an intermediate node on said first communication path includes re-routing means for re-routing data intended for continued transmission on said first communication path along said second communication path, said intermediate node being selected from a plurality of said intermediate nodes according to the method as claimed in claim 57.

73. A method of selecting an alternative path for carrying data intended for transmission along a communication path between the source node and a destination node, comprising selecting a plurality of alternate paths connected between an intermediate node of said communication path and said destination node, and selecting from said plurality of alternate paths, the path which shares the minimum number of links with said communication path between said intermediate node and said destination node.

74. A method as claimed in claim 73, further comprising selecting from said plurality of alternate paths, the path sharing the minimum number of intermediate nodes with said communication path between said intermediate node and said destination node.
